(19) United States
(12) Patent Application Publication
(10) Pub. No.: US 2014/0149196 A1
(43) Pub. Date: May 29, 2014

(54) OFFER REDEMPTION OF AN OFFER AT A RETAILER

(71) Applicant: Envizio, Inc., San Francisco, CA (US)

(72) Inventors: Youri Drozd, Fremont, CA (US); Leonid Kontsevich, San Francisco, CA (US); Seb Kiureghian, San Francisco, CA (US); Gary Dahl, San Francisco, CA (US)

(73) Assignee: Envizio, Inc., San Francisco, CA (US)

(21) Appl. No.: 14/064,738

(22) Filed: Oct. 28, 2013

Related U.S. Application Data
(63) Continuation-in-part of application No. 14/055,623, filed on Oct. 16, 2013.
Application No. 14/055,623 is a continuation-in-part of application No. 13/953,468, filed on Jul. 29, 2013.
Application No. 13/953,468 is a continuation-in-part of application No. 13/953,485, filed on Jul. 29, 2013.
Application No. 13/953,468 is a continuation-in-part of application No. 13/041,374, filed on Mar. 5, 2011.
Application No. 13/041,374 is a continuation-in-part of application No. 13/015,547, filed on Jan. 27, 2011.
Application No. 13/953,485 is a continuation-in-part of application No. 13/041,374, filed on Mar. 5, 2011.
Application No. 13/041,374 is a continuation-in-part of application No. 13/015,547, filed on Jan. 27, 2011.
(60) Provisional application No. 61/298,695, filed on Jan. 27, 2010.

(51) Int. Cl. G06Q 30/02

(52) U.S. Cl. CPC G06Q 30/0238
USPC 705/14.21; 705/14.38

(57) ABSTRACT

A system is provided for offer redemption of a retailer. A service provider includes one or more servers with engines and attached storage. The service provider is configured to be in communication with a mobile application running on a user mobile device of a user. The service provider is configured to be in communication with an advertiser and the retailer. The service provider is coupled to one or more processors with logic that enable an advertiser to create an offer campaign with details of the offer campaign stored in the storage. The details including at least one of, offer distribution rules and offer redemption rules. The one or more processors review transaction line items of the offer and making a determination to push or not push the offer redemption to a retailer check-out system.

### CROSS-REFERENCE TO RELATED APPLICATIONS

This application is a continuation-in-part of U.S. Ser. No. 14/055,623 filed Oct. 16, 2013, which is a continuation-in-part of U.S. Ser. No. 13/953,468 and U.S. Ser. No. 13/953,485, both filed Jul. 29, 2013, which applications are continuations-in-part of U.S. Ser. No. 13/041,374 filed Jun. 6, 2012 and Ser. No. 13/015,547 filed Jul. 28, 2011, which is a non-provisional of U.S. 61/298,695 filed Jan. 27, 2010, and U.S. 61/697,275 filed Sep. 5, 2012, all of which applications are fully incorporated herein by reference.

### BACKGROUND

1. Field of the Invention

The present invention is directed to systems for offer redemptions, and more particularly to a system for offer redemption of a retailer where a user communicates information to a service provider that allows the service provider to determine a specific retailer checkout system to receive an offer selected by the user.

2. Description of the Related Art

One of the most common concerns for many businesses is the need to develop fresh ways to acquire new customers and to retain current customers. There are currently a number of campaign offers and reward programs in place across many different merchants and products that attempt to build customer loyalty and attract new users. These types of programs tend to reward users for shopping frequently for products at the sponsoring merchant and are usually tied to the overall basket spend, rather than purchasing specific products, and certainly not for buying specific products over multiple shopping trips.

Incentive campaign reward programs, in which incentive companies contract with sponsoring companies for programs to promote sales of the sponsoring companies' products or services, are well-known. Incentive campaign reward programs include discount coupon programs; customer loyalty programs, such as frequent flyer programs, and promotional games, such as sweepstakes prizes, scratch-and-win games, and the like, in which a sponsoring company's products or services are won by successful participation in the incentive campaign reward program.

Incentive campaign reward programs offer rewards and incentives to modify behavior of individual users and to direct the users to some pre-determined action, such as the purchase of products or services upon visiting a retailer site, viewing advertising, testing a product, or the like. Companies use rewards and incentives to increase awareness of product offerings, to launch new products, to attract the attention of a newly identified audience, to differentiate products to encourage certain behavior, to obtain information, and for other purposes.

Traditional incentive campaign offers and rewards systems suffer drawbacks in terms of campaign creation, budgeting, convenience of tracking data, changing promotions, return on investment, and the like. For example, for a user who participates in multiple incentive programs it may take time and effort to track his or her participation in each program. For example, time is required to keep track of loyalty points earned in each separate incentive program. Therefore, when a user receives an offer to participate in an incentive program, the user may decide against participating in it, not because the incentive program is not attractive, but because the cost to the user, in terms of the time and effort to tracking another incentive program, exceeds the expected benefit of the incentive program. Accordingly, a user need has arisen for a streamlined system and method for tracking user participation in a variety of incentive programs from different campaign sponsors.

A similar problem exists for sponsoring companies who wish to offer campaign promotions. The collective costs of creating incentive campaign rewards programs, administering the programs, tracking the participation of users in the incentive campaign reward programs and fulfilling the rewards or prizes won in such incentive programs may exceed the benefits of offering the incentive campaign rewards program. These costs may be particularly high in instances where the activities associated with an incentive program must be carried out by different companies, or by different organizations within the same company. In just one small example, a clerk at a participating merchant may violate the terms of a particular campaign and allow a user to receive rewards on more than the campaign designated. Furthermore, the sponsor of a campaign may find itself rewarding its least economically attractive customers who are deal-driven and not likely to be brand advocates or loyalists in the future.

Existing incentive campaign offers and rewards programs do not meet the entire needs of both users and sponsors associated with incentive programs. One form of incentive campaign rewards program that is used extensively is that of promotional mailings. The processing of promotions, i.e., providing the appropriate check or discount coupon to the customer as a reward for the initial purchase, involves high volume and labor intensive activity, including collection, verification and organization of initial proofs of purchase and related information, preparation of the checks, coupons or other items using preprinted stock provided by the sponsor in connection with the particular promotion, and finally the sorting of individual items based on their mailing destinations.

At any given time, a typical provider of promotion services is involved with many different promotions of various sponsoring manufacturers. Preprinted forms, when provided by different sponsors, can vary in size and shape, thus creating the need to handle individual promotions separately. This increases handling expense, not only in added labor, but also in the mailing cost, as it is difficult with a single promotion to accumulate a volume of items sufficient to qualify for certain reduced postage rates, e.g. the reduced rate available for mail presorted by zip code of the destination. Manual recombination and sorting of items for multiple promotions would be prohibitively expensive.

Another form of a promotional program is coupon distribution and redemption. Many problems exist with the traditional coupon distribution and redemption system. For example, few users go through all the steps necessary to redeem coupons, and the users who do go to the trouble of redeeming coupons are disproportionately extremely price-sensitive and adept at extracting maximum value from incentive programs, often combining multiple coupons and store coupons to receive products at little to no out of pocket cost, making their redemptions a money-losing proposition for the product's manufacturer and limiting the effectiveness of the overall campaign. Additionally, many more attractive users forget to bring coupons that they have clipped and saved to the store, while even more disregard the coupons completely. Thus, reluctance by a “typical” user or a “desirable” user to take all necessary steps partially defeats the manufacturer's purpose for offering the purchase incentive in the first place. A manufacturer distributes coupons with the expectation that the coupons will induce sales of its product by offering a discount. However, when the coupon is forgotten or disregarded, the user is usually not aware of the incentive when he is selecting a product among different brands at the retailer store.

A further problem with traditional coupon redemption systems is verification. Because the verification of redemption conditions is performed by a check-out clerk using point of sale (POS) systems, sometimes the programming of the POS systems do not properly enforce a campaign's rules. As a result, campaigns are oftentimes overcharged for offers without the benefit of the required purchase.

The introduction of the digital computer and the computer network eliminates some of the inconveniences of conventional incentive campaign rewards programs, particularly those that relate to data tracking and manipulation. The digital computer is a powerful data processing tool that allows a user 30 to organize, store and analyze data at volumes and rates that would be impossible by any prior known techniques.

Computers have been used in connection with incentive campaign rewards programs and other programs that have characteristics in common with incentive programs, but known computer incentive programs address some, but not all of the drawbacks of traditional promotions. For example, U.S. Pat. No. 5,053,955 to Peach et al. discloses an improved process of printing and assembling coupons. Peach et al. discloses a computer-based system for merging certain information for various promotions, so that a single stream of data can be used as a source for printing and mailing coupons for multiple promotions. Thus, the system of Peach et al. reduces some of the paperwork associated with single-promotion systems, but it merely mitigates, rather than solves, the problems inherent in paper-based promotions.

Computer-based promotional games are also known. Such games include scratch-and-win games, treasure hunts, video pinball and the like. Such incentive programs have advantages over paper promotions, in that data regarding participation is easily stored and manipulated. However, existing incentive campaign reward programs do not solve all user and sponsor needs. In particular, such promotional games do not assist users in tracking participation in multiple promotions and do not assist sponsors in generating incentive programs, tracking participation in incentive programs and fulfilling rewards and prizes.

Computer-based systems exist for tracking some aspects of user participation in incentive programs. For example, U.S. Pat. No. 5,056,019 to Schultz et al. discloses an automated purchase reward accounting system and method. In particular, Schultz et al. discloses a marketing method for providing manufacturer purchase reward offers by automatically tracking the purchases of member users through the use of bar-coded membership cards and using the purchase records in a data processing system to determine if the required purchases have been made to earn a reward. Each member user receives a reward booklet disclosing the available reward offers, a periodic status report indicating the member user's progress toward earning rewards, and a reward certificate for those rewards earned. The card-based system of Schultz takes advantage of certain data processing capabilities of computer systems and certain data storage capabilities of electronic card technologies; however, among other drawbacks, the system of Schultz does not address the need for a system that assists sponsor companies in generating incentive programs, in tracking participation of users in multiple incentive programs, or in fulfilling rewards.

The computer network offers the possibility of improved systems for offering incentive programs and for tracking participation in an incentive program. By linking together several computers and by providing shared resources and cross-platform communications, the computer network provides improved access to sophisticated applications by users at remote locations.

One of the most widely accepted and heavily used networks is the Internet. The Internet is a global system of interconnected computer networks formed into a single world-wide network. A user, through the Internet, can interactively transmit messages with users in different countries. Similarly, a user in the U.S. connected to files and libraries and other jurisdictions such as Europe and Asia can download files for personal use. Accordingly, the Internet computer network provides strong communications functions similar to the communications functions provided by ham radio operators. Moreover, the Internet computer network acts like a universal library, providing electronic access to resources and information available from Internet sites throughout the world.

Various systems and methods are known which permit a sponsor to track data of multiple parties in databases and to update information in the databases based on transactions entered into by the parties to the transactions. For example, U.S. Pat. No. 5,664,115 to Fraser discloses an interactive computer system to match buyers and sellers of real estate using the Internet. Similarly, banks, credit card companies, and other financial institutions have developed computer-based systems that track client account information and update the information upon entry of various transactions. Some such systems involve use of electronic cards and operate over computer networks. Such systems have requirements peculiar to their respective industries, and none of the existing systems address all of the problems inherent in known incentive programs, particularly the problem of the need for an incentive program system that conveniently tracks participation while offering automated generation of incentive campaign reward programs and automated fulfillment of rewards won in incentive programs.

Computer incentive campaign reward programs are offered on the Internet; however, such systems are generally offered by a single sponsor and are generally limited to offering users the ability to participate in incentive programs. Known campaign offers and rewards systems do not offer sponsors the ability to conveniently generate incentive programs, to track participation of users in multiple incentive programs, or to provide for automated fulfillment of rewards.

Another important drawback of known computer incentive campaign rewards program systems is that the obligation to fulfill the rewards promised in a promotional campaign is often a logistically difficult and expensive task. The coordination of delivering or arranging for the retrieval of the rewards for the specified winner, in volumes that permit successful incentive programs, requires coordination of prize inventory, systems and information.

There are numerous problems with current incentive campaign offers and rewards programs. The users who receive and redeem offers, such as coupons, may not have the purchasing characteristics to make the incentive, provided by the offer, efficient for the campaign sponsor. When an offer, i.e., coupon, is distributed to a large population, and not tied to a specific individual, the number of coupon redemptions is not known at the time of creation and distribution. There is a great deal of uncertainty in determining the redemption rate of that offer (i.e., coupon), and the associated costs to merchants or product producers, e.g. the campaigner. Current campaign rewards programs do not provide the campaigner with certainty about how much of a campaign will be redeemed. Another problem with campaign reward programs and systems is that they do not look at the state of a campaign budget and make a decision as to whether it makes sense to give a proposed recipient the offer. Yet another problem is that campaign reward programs of today do not have a cross-retailer shopper's purchaser history and the campaign sponsor offer requirements, e.g. the budget of the campaign. Still a further problem of campaign reward programs is that there is a lack of control of the offer redemption mechanism. Yet another problem with campaign offers and rewards systems is that there is no convenient way to run multiple offers concurrently and target offers and specific user segments.

Conventional systems and methods are inefficient, and are prone to user fraud, miss-redemptions, and mishandling of coupons by retailer and employees. The settlement usually results in account receivable record that is not cleared until weeks after the expiration date of the paper coupon.

A system implementing digital distribution, validation, redemption and clearing of promotional offers has a significant potential to reduce costs, improve manufacturers' and retailers' operational efficiencies, and provide them with instant insight into the promotional campaigns. However, despite great potential, digital promotional offers require changes to multiple IT systems of retailers and manufacturers. Many of these are a result of requirement that a process implementing promotional offers must implement measures that ensure offer validity, and uniqueness.

There is a need for an improved system for offer redemption by a retailer. There is a further need for a system for offer redemption of an offer at a retailer where a user communicates information to a service provider, and the service provider determines a specific retailer checkout system to receive the selected offer.

### SUMMARY

An object of the present invention is to provide a system for offer redemption of a retailer where a user communicates information to a service provider that allows the service provider to determine a specific retailer checkout system to receive the offer selected by the user.

Another object of the present invention is to provide a system for offer redemption of a retailer where a user communicates information to a service provider that allows the service provider to determine a specific retailer checkout system to receive the offer selected by the user, with logic that allows a user who has created a request for an offer redemption to be received at the service provider.

Yet another object of the present invention is to provide a system for offer redemption of a retailer where a user communicates information to a service provider that allows the service provider to determine a specific retailer checkout system to receive the offer selected by the user, where the service provider includes an offer function.

A further object of the present invention is to provide a system for offer redemption of a retailer where a user communicates information to a service provider that allows the service provider to determine a specific retailer checkout system to receive the offer selected by the user, with logic that facilitates distribution of the offers to users on behalf of the advertiser.

Another object of the present invention is to provide a system for offer redemption of a retailer where a user communicates information to a service provider that allows the service provider to determine a specific retailer checkout system to receive the offer selected by the user, with logic that facilitates redemption of an offer with the retailer on behalf of the advertiser.

Still another object of the present invention is to provide a system for offer redemption of a retailer where a user communicates information to a service provider that allows the service provider to determine a specific retailer checkout system to receive the offer selected by the user, with logic that generates an offer metrics report.

A further object of the present invention is to provide a system for offer redemption of a retailer where a user communicates information to a service provider that allows the service provider to determine a specific retailer checkout system to receive the offer selected by the user, with an offer metrics report that includes at least one statistic regarding at least one of distribution and redemption of the offer.

Yet another object of the present invention is to provide a system for offer redemption of a retailer where a user communicates information to a service provider that allows the service provider to determine a specific retailer checkout system to receive the offer selected by the user, with logic that generates an invoice

Another object of the present invention is to provide a system for offer redemption of a retailer where a user communicates information to a service provider that allows the service provider to determine a specific retailer checkout system to receive the offer selected by the user, and \the user communicates directly with the retailer.

These and other objects of the present invention are achieved in a system for offer redemption of a retailer. A service provider includes one or more servers with engines and attached storage. The service provider is configured to be in communication with a mobile application running on a user mobile device of a user. The service provider is configured to be in communication with an advertiser and the retailer. The service provider is coupled to one or more processors with logic that enable an advertiser to create an offer campaign with details of the offer campaign stored in the storage. The details including at least one of, offer distribution rules and offer redemption rules. The one or more processors review transaction line items of the offer and making a determination to push or not push the offer redemption to a retailer check-out system. Logic allows a user who has created a request for offer redemption to be received at the service provider. The user communicates information to the service provider that allows the service provider to determine a specific retailer checkout system to receive the offer selected by the user.

### BRIEF DESCRIPTION OF THE DRAWINGS

FIG. 1 illustrates one embodiment of a system of the present invention.

FIG. 2 Illustrates a Network System with physical elements in one embodiment of the present invention.

FIG. 3 Illustrates one embodiment of the elements of the FIG. 1 system.

FIG. 4 is a flow chart illustrating an offer distribution in one embodiment of the present invention.

FIG. 5 flow chart illustrating offer issue in one embodiment of the present invention.

FIG. 6 is a flow chart illustrating one embodiment of the operation of an offer redeemer of the present invention.

FIG. 7 Illustrates one embodiment of a retailer gateway in one embodiment of the present invention.

FIG. 8 is a flowchart illustrating one embodiment of the operation of a retailer checkout system of the present invention.

FIG. 9 is a flowchart illustrating an embodiment of clearing with the present invention.

FIG. 10 illustrates one embodiment of payments for offers relative to a financial institution coupled to the advertiser and the retailer.

FIG. 11 illustrates one embodiment of a statistical processor that can be used in targeting of offers to users.

FIG. 12 is a flowchart illustrating the initial development of a baseline database for targeting.

FIG. 13 is a drawing of a networked environment according to various embodiments of the present invention.

FIG. 14 is a drawing of various components of an offer application included in the service provider according to various embodiments of the present invention.

FIG. 15 is a drawing illustrating a user interface that can be used by a user in various embodiments of the present invention.

FIG. 16 is a drawing of an example of a user interface rendered by a user in various embodiments of the present invention . . . .

FIG. 17 is a drawing of an example data flow between various components from the networked environment of FIG. 13 according to various embodiments of the present invention.

FIG. 18 is a drawing of an example data flow between various components from the networked environment of FIG. 13 according to various embodiments of the present invention.

FIG. 19 is a drawing of an example data flow between various components according to various embodiments of the present invention.

FIG. 20A is a drawing of an example data flow between various components from the system according to various embodiments of the present invention.

FIG. 20B is a drawing of an example data flow between various components from the system according to various embodiments of the present invention.

FIG. 21 is a flowchart illustrating one example of functionality implemented as portions of the system in a computing device according to various embodiments of the present invention.

FIG. 22 is a flowchart illustrating one example of functionality implemented as portions of the system executed in a computing device according to various embodiments of the present invention.

FIG. 23 is a flowchart illustrating one example of functionality implemented as portions of the service provider executed in a computing device in one embodiment of the present invention.

FIG. 24 is a flowchart illustrating one example of functionality implemented as portions of the system executed in a computing device according to various embodiments of the present invention.

FIG. 25 is a schematic block diagram that provides one example illustration of a computing device employed according to various embodiments of the present invention.

### DETAILED DESCRIPTION

As used herein, the term “engine” refers to software, firmware, hardware, or other component that is used to effectuate a purpose. The engine will typically include software instructions that are stored in non-volatile memory (also referred to as secondary memory). When the software instructions are executed, at least a subset of the software instructions is loaded into memory (also referred to as primary memory) by a processor. The processor then executes the software instructions in memory. The processor may be a shared processor, a dedicated processor, or a combination of shared or dedicated processors. A typical program will include calls to hardware components (such as I/O devices), which typically requires the execution of drivers. The drivers may or may not be considered part of the engine, but the distinction is not critical.

As used herein, the term “computer” is a general purpose device that can be programmed to carry out a finite set of arithmetic or logical operations. Since a sequence of operations can be readily changed, the computer can solve more than one kind of problem. A computer can include of at least one processing element, typically a central processing unit (CPU) and some form of memory. The processing element carries out arithmetic and logic operations, and a sequencing and control unit that can change the order of operations based on stored information. Peripheral devices allow information to be retrieved from an external source, and the result of operations saved and retrieved.

As used herein, the term “computer program” or just a program is a sequence of instructions, written to perform a specified task with a computer. A computer requires programs to function, typically executing the program's instructions in a central processor. The program has an executable form that the computer can use directly to execute the instructions. The same program in its human-readable source code form, from which executable programs are derived (e.g., compiled), enables a programmer to study and develop its algorithms. A collection of computer programs and related data is referred to as the software. Source code is written in a programming language that usually follows one of two main paradigms: imperative or declarative programming. Source code may be converted into an executable file (sometimes called an executable program or a binary) by a compiler and later executed by a central processing unit. Alternatively, computer programs may be executed with the aid of an interpreter, or may be embedded directly into hardware. Computer programs can be categorized along functional lines: system software and application software. Two or more computer programs may run simultaneously on one computer from the perspective of the user, a process known as multitasking.

As used herein, the term “Internet” is a global system of interconnected computer networks that use the standard Internet protocol suite (TCP/IP) to serve billions of users worldwide. It is a network of networks that consists of millions of private, public, academic, business, and government networks, of local to global scope, that are linked by a broad array of electronic, wireless and optical networking technologies. The Internet carries an extensive range of information resources and services, such as the inter-linked hypertext documents of the World Wide Web (WWW) and the infrastructure to support email. The communications infrastructure of the Internet consists of its hardware components and a system of software layers that control various aspects of the architecture.

As used herein, the term “extranet” is a computer network that allows controlled access from the outside. An extranet can be an extension of an organization's intranet that is extended to users outside the organization that can be partners, vendors, and suppliers, in isolation from all other Internet users. An extranet can be an intranet mapped onto the public Internet or some other transmission system not accessible to the general public, but managed by more than one company's administrator(s). Examples of extranet-style networks include but are not limited to:
LANs or WANs belonging to multiple organizations and interconnected and accessed using remote dial-up
LANs or WANs belonging to multiple organizations and interconnected and accessed using dedicated lines
Virtual private network (VPN) that is comprised of LANs or WANs belonging to multiple organizations, and that extends usage to remote users using special “tunneling” software that creates a secure, usually encrypted network connection over public lines, sometimes via an ISP.

As used herein, the term “Intranet” is a network that is owned by a single organization that controls its security policies and network management. Examples of intranets include but are not limited to:
A LAN
A Wide-area network (WAN) that is comprised of a LAN that extends usage to remote employees with dial-up access
A WAN that is comprised of interconnected LANs using dedicated communication lines
A Virtual private network (VPN) that is comprised of a LAN or WAN that extends usage to remote employees or networks using special “tunneling” software that creates a secure, usually encrypted connection over public lines, sometimes via an Internet Service Provider (ISP).

For purposes of the present invention, the Internet, extranets and intranets collectively are referred to as (“Network Systems”).

As used herein, the term “network protocol” defines rules and conventions for communication between network devices. Protocols for computer networking all generally use packet switching techniques to send and receive messages in the form of packets. Network protocols include mechanisms for devices to identify and make connections with each other, as well as formatting rules that specify how data is packaged into messages sent and received. Some protocols also support message acknowledgement and data compression designed for reliable and/or high-performance network communication. Hundreds of different computer network protocols have been developed each designed for specific purposes and environments.

As used herein the term “wireless communication” means all procedures and forms of connecting and communicating between two or more devices using a wireless signal through wireless communication technologies and devices. Wireless communication generally works through electromagnetic signals that are broadcast by an enabled device within the air, physical environment or atmosphere. The sending device can be a sender or an intermediate device with the ability to propagate wireless signals. The communication between two devices occurs when the destination or receiving intermediate device captures these signals, creating a wireless communication bridge between the sender and receiver device. Wireless communication has various forms, technology and delivery methods including: satellite, mobile wireless network, infrared, Bluetooth and the like.

As used herein, the term “database” is used broadly to include any known or convenient means for storing data, whether centralized or distributed, relational or otherwise.

As used herein, the term “mobile device” includes but is not limited to, a cell phone, such as Apple's® iPhone®, other portable electronic devices, such as Apple's ®iPod®Touches, Apple's® iPods®, and mobile devices based on the Google ®Android® operating system, and any other portable electronic device that includes software, firmware, hardware, or a combination thereof that is capable of at least receiving the signal, decoding if needed, exchanging information with a transaction server to verify the buyer and/or seller's account information, conducting the transaction, and generating a receipt. Typical components of a mobile device may include but are not limited to persistent memories like flash ROM, random access memory like SRAM, a camera, a battery, LCD driver, a display, a cellular antenna, a speaker, a Bluetooth® circuit, and WIFI circuitry, where the persistent memory may contain programs, applications, and/or an operating system for the mobile device.

As used herein, “Offer” is defined as containing a product(s) name, product(s) image, product(s) copy, reward value, reward limit, time period, and terms.

As used herein, “Redeem” or “Redemption” is a campaign reward that is compensation for the successful completion of the offer, either financial or non-financial remuneration.

As used herein, “Advertiser” is defined as an entity, or an agent for the entity, paying for the redemption authorizing the offers.

As used herein, “User” is defined as a user who purchases products or services, submits receipts, views offers, and/or receives rewards.

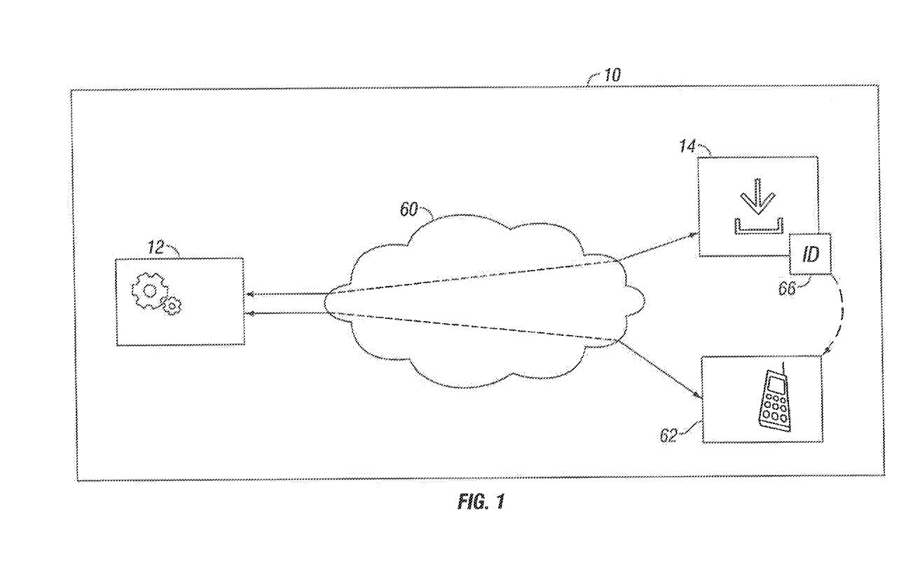

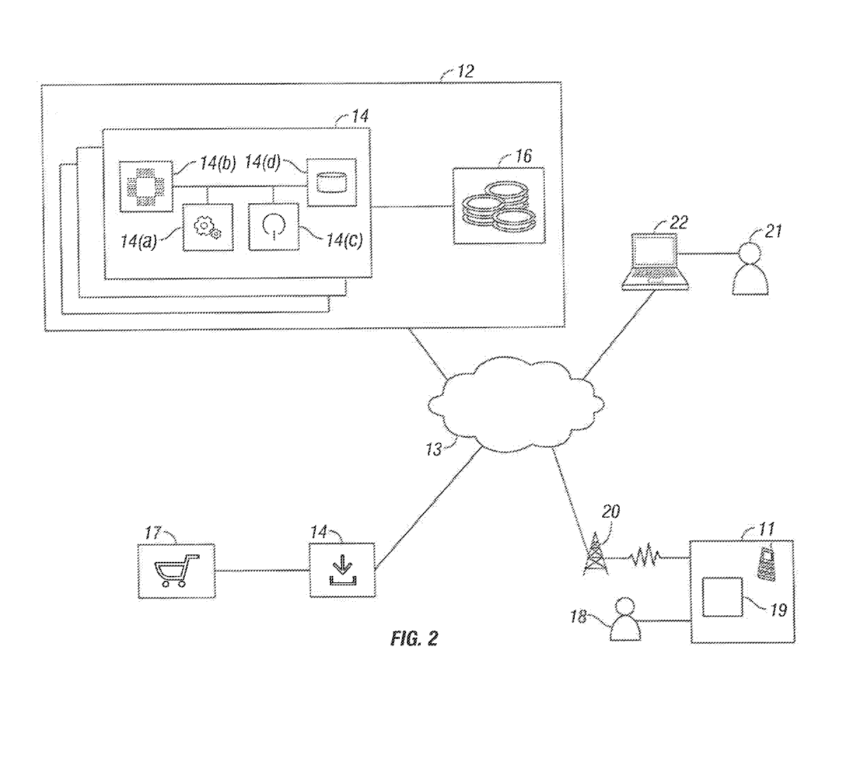

Referring to FIGS. 1 and 2, in one embodiment of the present invention, a campaign offer system 10 provides offers to users 30 via their mobile devices 62. A service provider 12 uses network systems 60 to communicate with a mobile device 62 and with a retailer gateway 38, which interfaces with retailer checkout system 64. A unique identifier 66 is assigned to each retailer checkout system 64 location and is captured by a user's mobile device 62. The unique identifier is transmitted to the service provider 12, which effects transactions between the user 30 and the retailer checkout system 64 via the retailer gateway 38. A service provider 12 has one or more servers 14 with engines and attached storage or database 16. Each of a one or more server 14 with engines includes a processor 14(a), operating memory 14(b), I/O devices 14(c) and non-volatile storage 14(d). Database 16 contains records of available offers, offer instances, e.g., offers issued to specific user 30 or users, user accounts, transaction histories, offer redemption records and the like. In one embodiment, the database 16 includes information for performing at least one of offer: (i) defining, (ii) distributing, (iii) issuing, (iv) redeeming and (v) clearing. A user 30 interacts with mobile application 70 running on his mobile device 62, which is connected through wireless network 72 and the network systems 60 to the service provider 12. An advertiser 68 interacts via a communication device 22 with service provider 12.

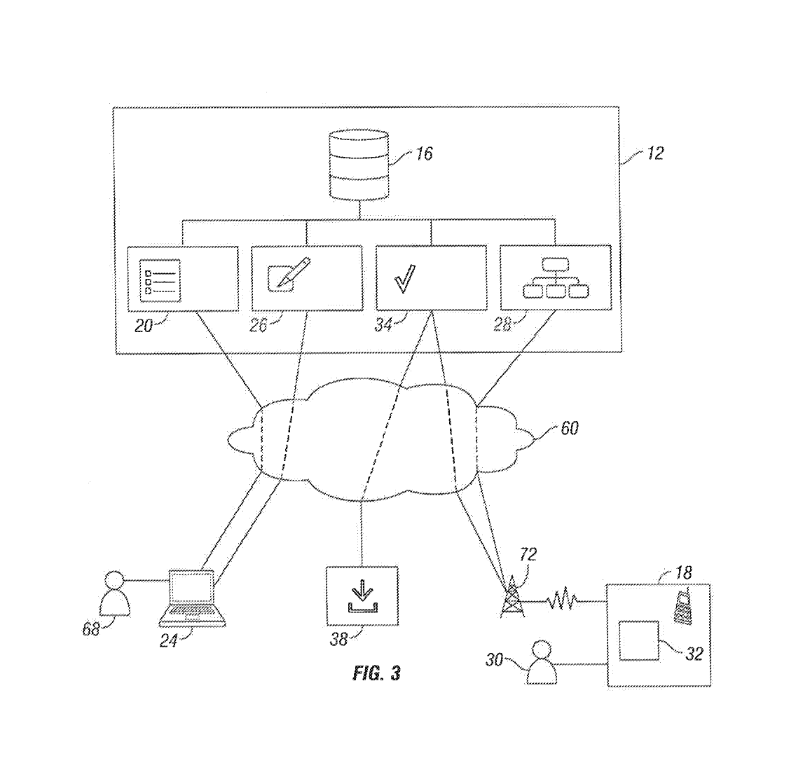

Referring now to FIG. 3 the service provider 12 includes an offer manager 20 that uses Network Systems 60 to communicate with a communication device 24. The offer manager 20 can be in communication with at least one of, a web, a desktop, a mobile application and an advertiser 68 operated offer management application. In one embodiment, the communication device 24 is a web browser. In one embodiment, the advertiser 68 uses a web application to provide the offer manager 23 with information necessary to create an offer, the offer manager 23 creating an offer by making a record in the database.

The communication device 24 can be used to communicate instructions, service requests and the like from an advertiser 68. The offer manager 20 uses these instructions, and the like, to create and modify offers by modifying records in the database 16. The records can include a product identifier. In one embodiment, the product identifier includes at least one of, a UPC code, an EAN codes and a PLU.

Acting on the service requests by a user 30 using the mobile application 32 running on the user's mobile device 62, and the offer information stored in the database 16, the offer distributor 28 sends available offers to the user 30 via the mobile application 32.

An advertiser 68 creates an offer campaign. The relevant details of the offer campaign are communicated with the service provider 12 via the communication device 24. In one embodiment, the relevant communicated details include but are not limited to, the offer distribution and redemption rules. These are then stored in the database 16. In one embodiment, the distribution rules can contain targeting information. As non-limiting examples, the targeting information can include but is not limited to, user's geographic location, purchasing history, vital statistics, retailer-based, basket-based targeting, shopper-based, user purchase behavior, competitive market share analysis, and the like.

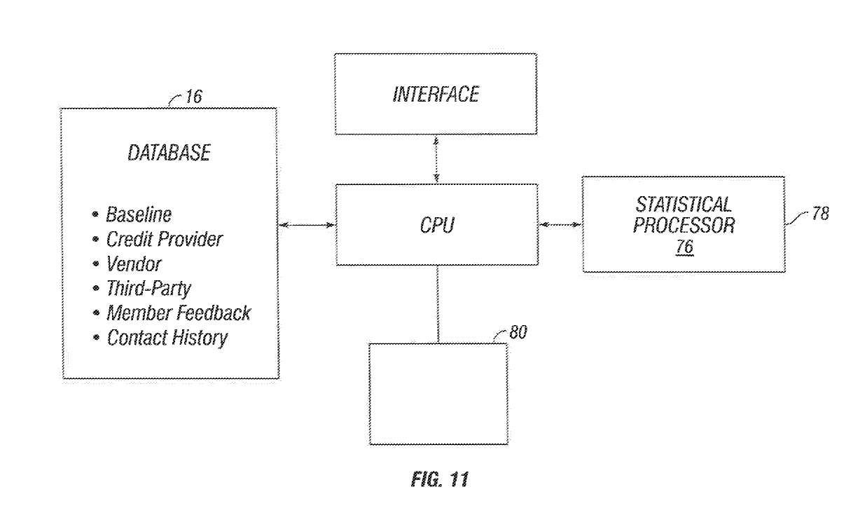

Referring now to FIG. 11, in one embodiment, a statistical processor 76 is used to refine and generate user targets for the various vendor offers, as illustrated in WO 1999033012, fully incorporated herein by reference. The user targets are individually contacted via a variety of techniques well known in the art.

In one embodiment, all relevant information relative to a user target is output from the database 16 and can be provided to a front end 78 of a statistical processor. The front end 78 applies a statistical analysis such as multiple regression and/or LOGIT, chi-square or the like to the input data. Single or multiple variant regression analysis can be used for statistical techniques that provide low predictive error and high discrimination. It identifies the combination of characteristics that can predict specific user behavior. The result of the multiple regression analysis is a regression equation, which is a tool used to store and rank users 30 prospects.

The LOGIT regression, also known as the Rodbard of Probit regression is a type of discrete choice analysis that can be uses to predict how well a product or service will be received in the market. Analogous in many ways to conjoint analysis, discrete choice analysis differs by having respondents choose one of several product packages or options presented. Discrete choice modeling can be used to answer various marketing questions. It can provide direct predictive estimates of market share for a new or existing product. It can also be used to make estimates of future market demand. Many different data collection techniques can be used to implement a discrete choice model.

In one embodiment, the various information provided about each individual user 30 is statistically matched to baseline information, in order to determine which user 30 is most likely to accept which offer. The matching can be provided by a statistical processor back end which assigns offers to users 30 based on the statistical analysis provided by the front end 78. In one embodiment, the back end segments the users 30 by various advertiser offers that statistically would be most interesting to the user 30. The results of the sorting are stored.

The results of the segmentation and sorting for all of the individual users 30 whose data is analyzed is provided for marketing to the users 30. In one embodiment, the results of the marketing efforts are reported to a feedback database 80, which maintains a record as to which users accepted or rejected which offers. The feedback database 80 can be supplemented with information regarding the use of the offered products or services by the users 30 over time. It will be appreciated that feedback database 80 can also be database 16.

In one embodiment, all of this information is compiled in the feedback database 80, and fed back to the statistical processor front end 78 for subsequent analysis and use in refining the baseline information that is used in targeting subsequent users 30. By using the feedback data, the accuracy of the profiles which define characteristics of users most likely to accept and use a particular offer is constantly improved.

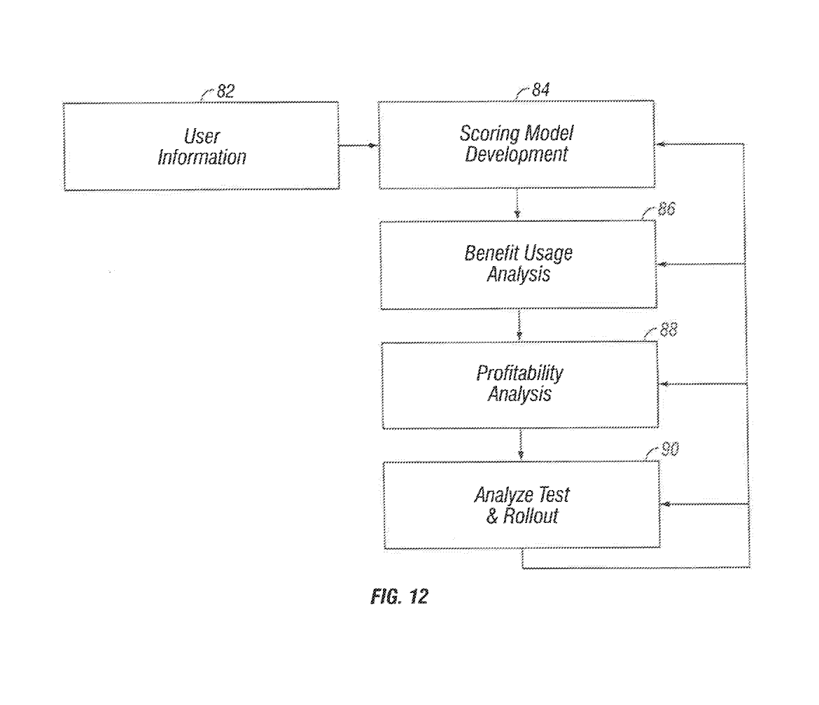

FIG. 12 is a flowchart illustrating an initial development of the baseline database. In one embodiment, user 30 information is provided from a user information database 82 to a scoring model development process 84. The scoring model development process 84 segments users 30 according to the user information based on which users 30 would be interested in an offer under consideration. The users 30 with the highest likelihood of positively responding to an offer (i.e., those with the highest “scores”) can then be contacted. The actual use by the users 30 is analyzed at box 86. In one embodiment, a profitability analysis can be performed at box 88. In one embodiment, the benefit usage analysis may simply be an analysis of which users 30 accepted the offer. Alternatively, the usage analysis may be conducted over a period of time. The profitability analysis can take various factors into account, such as the number of users 30 that have to be contacted in order to generate a sale and the number of sales generated overall. The results of the benefit usage analysis and profitability analysis are analyzed at box 90.

Offers are then distributed to users 30 as specified by the distribution rules that are retrieved from the database 16. These offers are distributed by system 10.

The offers are redeemed by the users 30 at various retailers 64 in response to the offer redemption rules retrieved from the database 16. The redemption details and transaction information are captured by the retailer gateway 14, transmitted to the service provider 12 and stored in the database 16.

In one embodiment, the advertiser 68 or the system 10 performs an analysis of data in the database 16 which is knowledge discovery of the data. In one embodiment, the data collection retailer gateway 38 transmits transaction data to the service provider 12 which stores it in the database 16. In one embodiment, a statistical analysis of data from the database 16 is performed. Examples of the statistical analysis are found in U.S. Pat. No. 8,326,658, WO 2007048008, WO 2002023438, WO 2012113756, WO 2012177766, and the like, all fully incorporated herein by reference.

In one embodiment, data mining is used for targeting of offers to users. User segmentation can be performed by extracting from the data previously unknown groups of users that exhibit certain behavior patterns, including but not limited to cluster analysis. In one embodiment associate rule learning is performed by extracting dependencies, including but not limited to a market basket analysis. As a non-limiting example, a market basket analysis can by the type of buyers of beer that also are buyers of diapers. Anomaly detection can be performed to find unusual patterns. This can help reduce misuse of offers. As a non-limiting example, this can be limiting offer distribution to extreme users 30 of coupons, e.g., those who overuse coupons. Result interpretation is performed. In one embodiment this can be data mining. Decision support is used for campaign modification or formulation of future campaigns. The evaluation of a campaign performance can be performed in real time, or for any selected period of time. A marketing formulation strategy can then be created. The analysis can be performed by analysis programs running in the context of the service provider 12, or by advertiser's devices accessing the data through the service provider 12 and communication device 22.

The analysis can include a predictive model function that uses information stored in the database 16 to determine values representing statistical correlations. In response to the analysis of data in the database 16, decisions can be made relative to who should receiver which offers. The analysis can utilize the following information: users 30 who have viewed the offer; users 30 who have redeemed previous offers; money spent on a product or service by a user 30; offers made to users 30; money spent on product per a selected dollar amount in offers; performance against benchmarks of the campaign; and the like.

In one embodiment, the database 16 includes taxonomy of products from different advertisers 68.

The analysis performed with data from the database 16 can use a set of general patterns that tend to appear across the retailer checkout system 64 line items when referring to a specific manufacturer's product or a certain type of product. The system can include an analytics engine that implements rules to extract useful product information.

In one embodiment, the system 10 or retailer 68 predicts a probability that a user 30 will redeem an offer and estimate the a reward the user 30 will be owed when it redeems the offer, calculates an expected amount of a campaign budget that will be consumed if the user 30 is presented with that offer, and estimates a payout that the advertiser 68 is likely to realize by providing the user 30 with the offer.

In one embodiment, the analysis uses product or category purchasing behavior of a group of users 30 who have received an offer or other marketing intervention.

In one embodiment, the system 10 can perform an analysis of a market share for different advertisers 68 competing in a particular category.

In one embodiment, the system 10 or advertiser uses product or category purchasing behavior of a group of users 30 who have received an offer or other marketing intervention.

In response to this analysis, instructions from the advertiser 68 are provided to the system 10 to make modifications to the distribution and redemption rules of the original campaign. This can be repeated any number of times to provide for a continued refinement of the campaign, and produces a targeting of users 30. Subsequent offer distributions to users 30 are based on the modified campaign distribution rules.

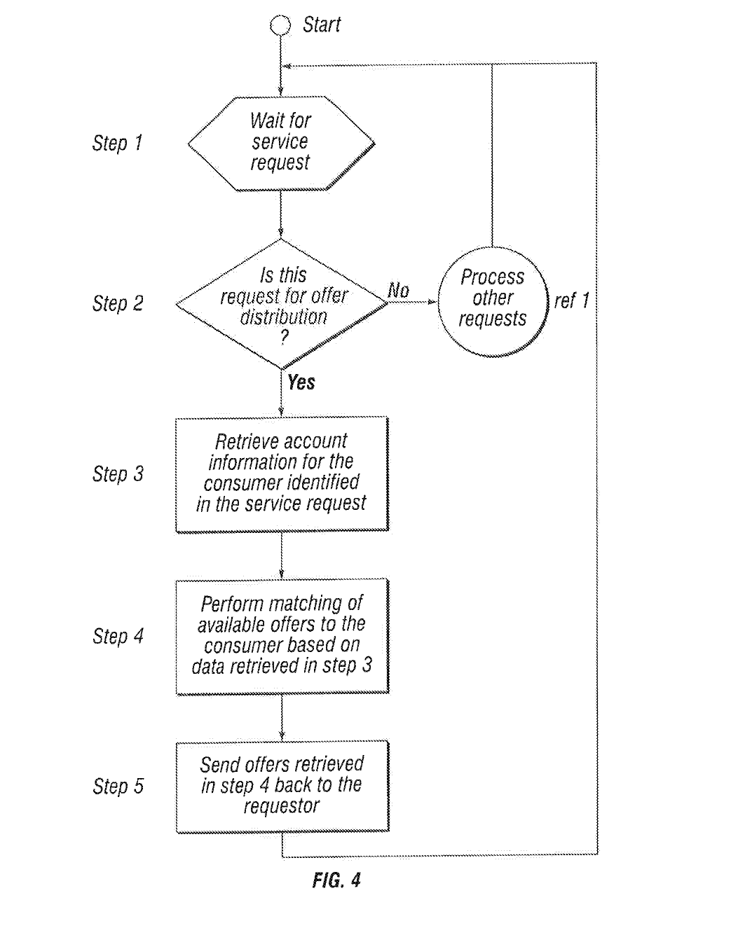

In one embodiment, the user 30, using the mobile application 32, provides offer distributor 28 details selected from at least one of, a user 30 identifier, user 30 preferences, location information, and in response the offer distributor 28 responds with the list of offers for which the user 30 is eligible, as illustrated in the offer distribution flowchart of FIG. 4.

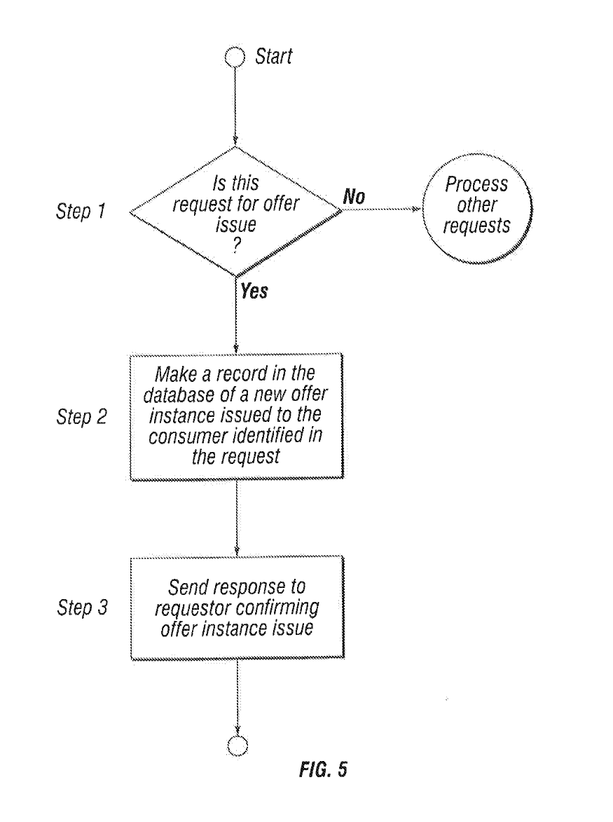

In one embodiment, the user 30 instructs the mobile application 32 to save a specific offer, which causes the mobile application 32 to communicate with the offer distributor 28. The communication with the offer distributor generates a unique offer instance and makes a record linking the offer instance with a user 30 identifier, as illustrated in the offer issue flowchart of FIG. 5, note that FIG. 5 relates to ref 1 of FIG. 4.

In one embodiment, the user 30 instructs the mobile application 32 to redeem one or more previously saved offers by acquiring a retailer checkout system 64 location identifier (token). The mobile application 32 then communicates the token to the offer redeemer 34. The offer redeemer 34 communicates with the retailer gateway 38 that is identified by the token.

Referring back to FIG. 3, in one embodiment, the system 10 includes an offer redeemer 34 that uses the Network Systems 60 to communicate with the user's mobile application 32.

In one embodiment, the user 30 instructs the mobile application 32 to redeem one or more previously saved offers by acquiring a retailer checkout system 64 location identifier (token). The mobile application 32 then sends the redemption service request including the token to the offer redeemer 34. The offer redeemer 34 communicates with the retailer gateway 38 that is identified by the token.

In one embodiment, the offer redeemer 34 receives service requests including current transaction information from the retailer gateway 38.

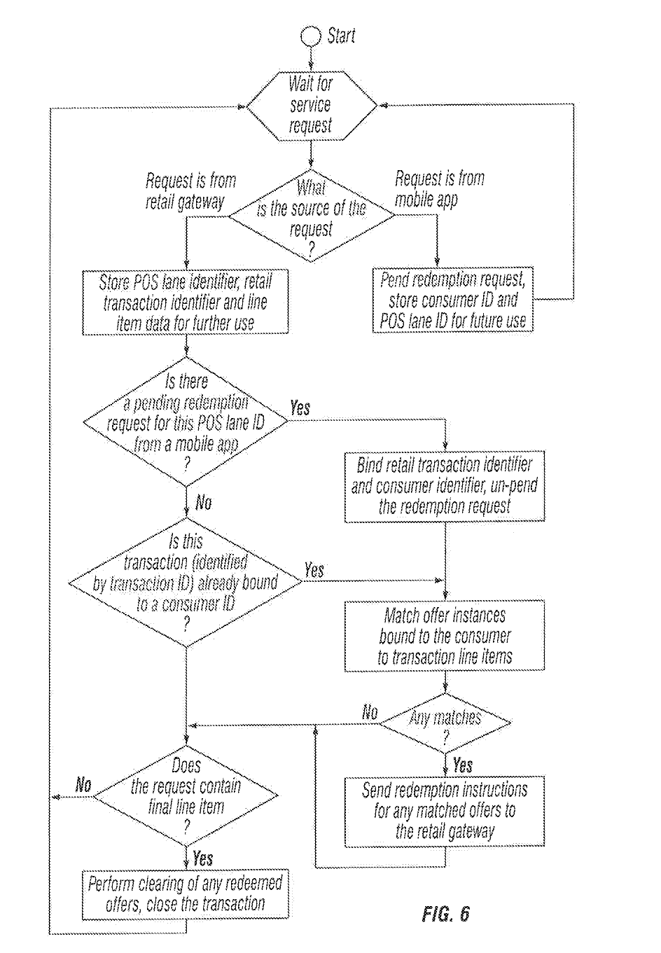

The offer redeemer 34, (i) receives current transaction information from the retailer gateway 38, (ii) receives offer redemption requests containing information identifying the user 30 and a retailer checkout system 64 identifying information from the mobile application 32, (iii) matches offer redemption requests against current transaction data by querying the database 16, (iv) sends offer redemption data requests for matched offer instances, including but not limited to a discount amount corresponding to an offer, to the retailer gateway 38, (v) receives a complete transaction record from retailer gateway 38, and (vi) performs clearing of offer redemptions by making the record containing the information identifying redeemed offer instances and completed transaction information in the database 16, as illustrated in the offer redemption flowchart of FIG. 6. In one embodiment, the service provider 12 makes a record in the attached database 16 with sufficient transaction information to perform the clearing of the transaction. As a non-limiting example, the sufficient transaction information includes at least one of, a retailer location identifier, a specific offer identifier, timestamp, a method of offer redemption, and transaction identification information. In one embodiment, a billing subsystem 40 issues reports, invoices and payment instructions based on the offer distribution and clearing data retrieved from the attached storage 16.

Referring back to FIG. 3, the system 10 also includes a reporting subsystem 26 in communication with communication device 24 via Network Systems 60. The reporting subsystem 26 provides the advertiser 68 with reports prepared in response to the instructions entered by the advertiser 68 by querying the database 16.

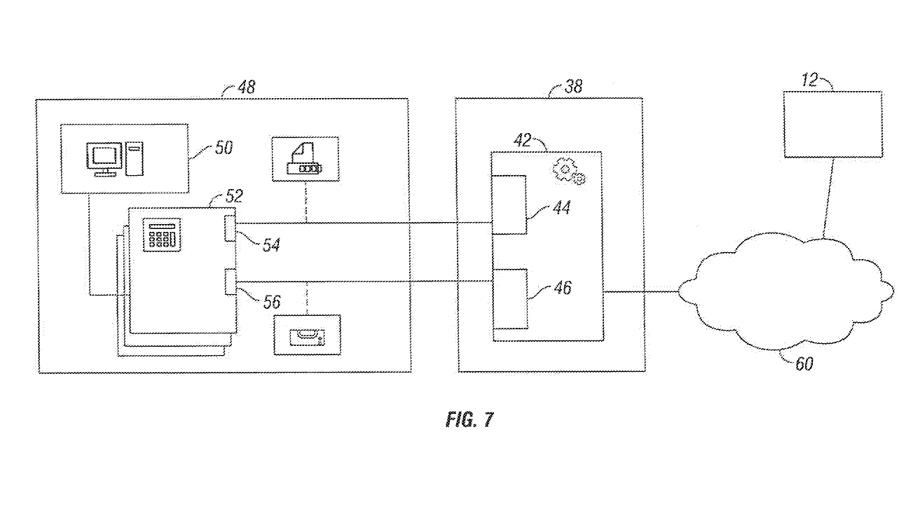

Referring to FIG. 7, in one embodiment, a retailer gateway 38 is in communication with service provider 12. The retailer gateway 38 communicates with the retailer checkout system 64 via existing retailer checkout system peripheral device communication protocols without a need to modify the communications protocols or modify a retailer checkout system software code

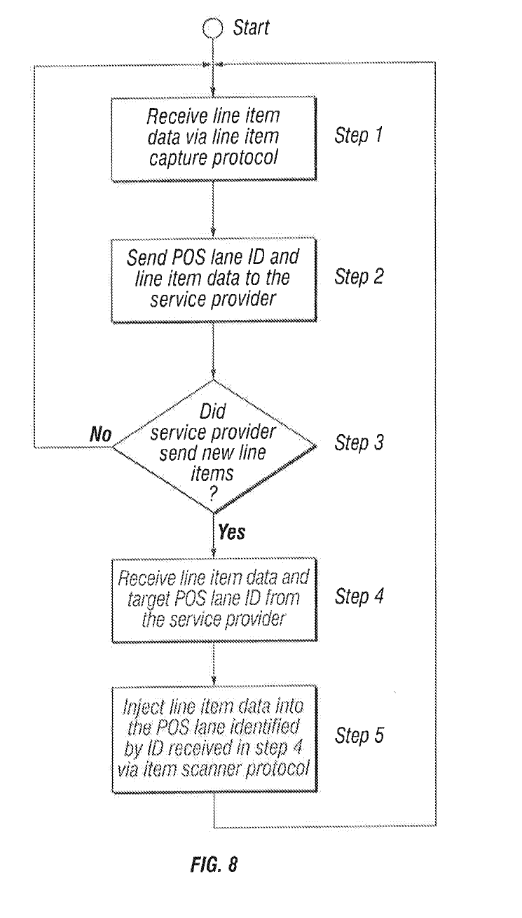

Retailer gateway 38 includes a processing unit 42 equipped with peripheral communication ports 44 emulating line item capturing protocol, including but not limited to, UPOS Fiscal Printer protocol, LAN Capture protocol, UPOS Line Item Display protocol, and the like. Processing unit 42 includes communication ports 46 emulating item scanning protocol, which as a non-limiting example can be UPOS Barcode Scanner Protocol and the like. Retailer gateway 38 communicates via Network Systems 60 to the service provider 12. FIG. 8 is a flowchart illustrating operation of the retailer checkout system 64.

Retailer gateway 38 is in communication with a retailer checkout system 64, which as a non-limiting example can be a POS system 64 containing a store controller server 50 and a plurality of POS lane registers 52, each equipped with peripheral communication ports, 54 that implement line item capturing protocol, including but not limited to, UPOS Fiscal Printer protocol, LAN Capture protocol, UPOS Line Item Display protocol, and the like. Peripheral communications ports 56 implement item scanning protocol, such as UPOS Barcode Scanner Protocol and the like.

It will be appreciated that the ports 42, 44 54 and 56 can be separate entities, different USB ports and can use the same cable, or logical ports.

In one embodiment, processing unit 42 can be a driver.

In another embodiment, processing unit 42 can be an OPOS service object, an OPOS control object, or a combination thereof.

The retailer gateway 38 emulates a plurality of retailer checkout system peripheral devices to retrieve and inject in real time line items associated with an open retailer transaction.

In one embodiment, the retailer checkout system 64 emulates a peripheral barcode scanner device to inject offer line items. In another embodiment, the retailer checkout system 64 emulates a peripheral payment terminal device to inject payment line item. In one embodiment, the retailer gateway 38 is two or more processing units 42 in communication with each other. The processing units 42 can be physical microprocessor-based devices with physical communication ports.

In another embodiment, the processing units 42 are logical devices that share processing hardware with one of the components of the retailer checkout system 64.

In one embodiment, in response to the communication of details by the retailer gateway 38, the offer redeemer 34 matches offer instances in database 16 that are associated with a user ID against transaction details. The transaction details can be basket line items, and the offer redeemer 34 passes offer instances to the retailer gateway 38. The retailer gateway 38 communicates to the retailer checkout system 64, and in response the retailer checkout system 64 reduces an amount due by an amount equal to a save value of the offers.

The retailer gateway 38 then communicates to the service provider 12 the results of a closing of a transaction. In one embodiment, the system 10 performs real time clearing of offer redemption.

The retailer checkout system 64 performs at least one of, (i) a manual entering of an item identifier, or (ii) a scanning of item identifiers for items purchased by the user 30 during a checkout. The retailer gateway 38 communicates with a retailer checkout system 64 via existing retailer checkout system 64 peripheral device communication protocols, as recited above this is achieved without a need to modify the communications protocols or modify a retailer checkout system software code. A user 30 begins a potential redemption of offers when the retailer checkout system 64 enters item identifiers of products after the user 30 enters a retailer's location identifier using the user's mobile device 62. The service provider 12 checks if there are redemption offers from the mobile device 62 that meet an advertiser's 68 redemption rules for items in the transaction. When a redemption offer meets the advertiser's 68 redemption rules, the retailer gateway 38 sends a redemption code to the retailer checkout system 64. The retailer gateway 38 then captures a line item relating to the redemption code that is recorded in the storage.

In one embodiment, the service provider 12 checks if there are offers presented to the user 30 of the mobile device 62. The line item can be captured by the retailer gateway 38. The retailer gateway 38 communicates the line item to a backend of the system 10.

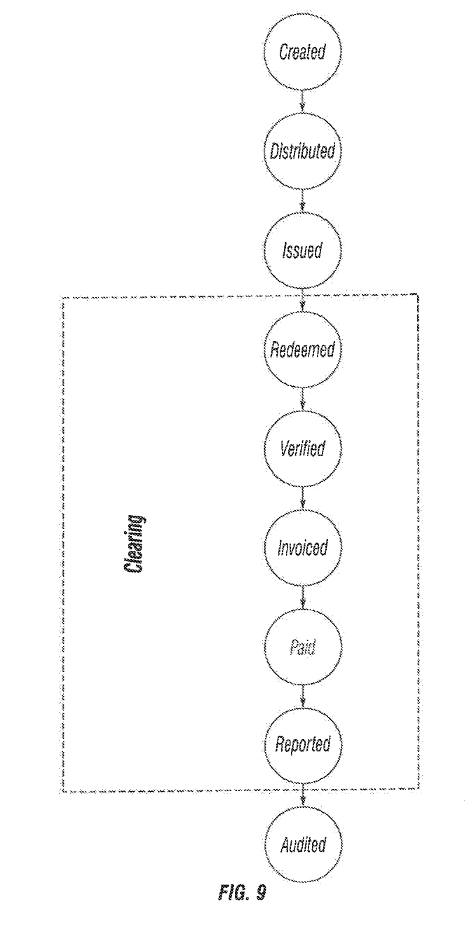

In one embodiment, clearing of offers is performed simultaneously with the checkout. FIG. 9 is a flowchart illustrating an embodiment of clearing with the present invention.

The system 10 provides that an offer of an advertiser 68 meets parameters set forth by the advertiser 68. The system 10 checks that offer issue conditions are met prior to linking an offer to a user 30. A record of the offer is made in the database. In one embodiment, the system 10 provides that offers are redeemed only in accordance with the offer redemption conditions set forth by the advertiser 68. The retailer gateway 38 passes retailer transaction information to the service provider 12. This information can include but is not limited to, sequence number, retailer checkout system 64 lane ID, cashier ID and store ID, timestamp, any line item details for the retail transaction.

Redemption offer line items are uniquely identifiable within the transaction. As non-limiting examples, uniquely identifiable can be by, redemption code, line item number in a list of ordered transaction line items, line item timestamp and a line item textual description. In one embodiment, a redemption code includes a variable field that is set by the retailer gateway 38 to a number that is generated by the gateway 38 so that the redemption code is unique within the transaction.

In one embodiment, the service provider 12 makes a record that links the transaction information received from the retailer gateway 38 with the redemption offer that is redeemed.

In one embodiment, the system 10 invoices the advertiser 68 for each redeemed offer instance within a time frame established between the advertiser 68 and the system 10. Payments relative to the offers are processed within a time frame established by the advertiser 68 and the system 10.

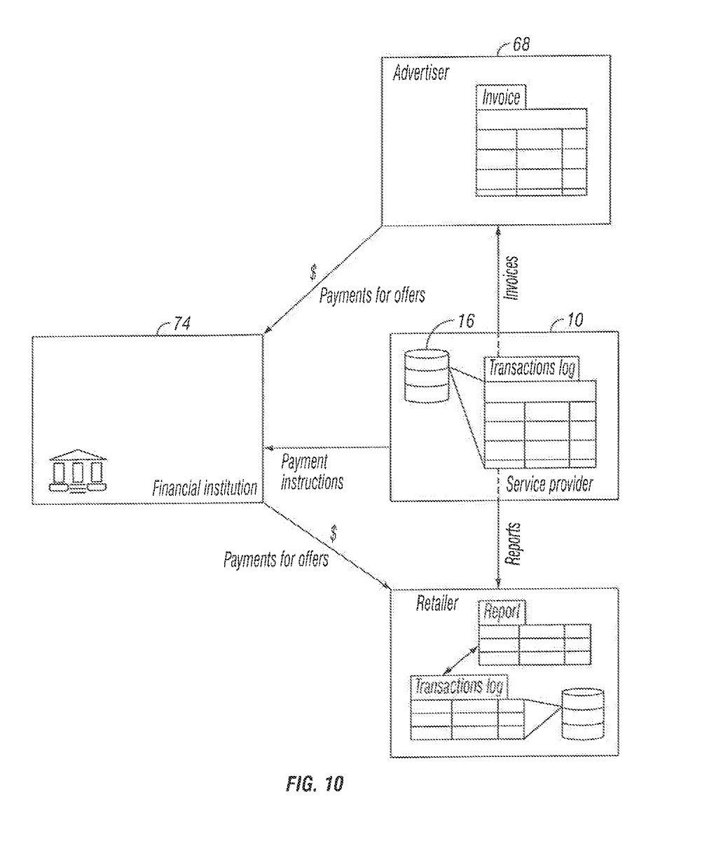

In one embodiment, payments are issued automatically by the system 10. Referring to FIG. 10, advertiser 68 and system 10 are in communication with a financial institution 74. The financial institution 74 can be the user's financial institution, a non-affiliated payment institution and the like. The financial institution can include or be associated with a variety of databases, including but not limited to product, user with user information, and transaction that can contain all types of transaction information. In one embodiment, the system 10 contacts a payment system, which may then communicate with a financial card issuing institution to either authorize or deny the transaction.

The advertiser 68 communicates the payment instructions for offers to the financial institution 74, system 10 communicates payment instruction to the financial institution 74, and the actual payments for the offers are sent from the financial institution 74 to the retailer.

In one embodiment, when the offer is issued, it is assigned a unique offer instance identifier. This instance identifier is stored in database 16. When the offer is redeemed the retailer gateway 38 captures transaction data. In one embodiment, the transaction data is sufficient data to identify the specific transaction. As a non-limiting example, the data can be one or more of, retailer store identifier (globally unique); lane number; retail transaction sequence number (unique within lane); position of redemption line item(s) within retailer transaction; redemption code; cashier ID; timestamp and the like.

The retailer gateway 38 communicates this data to the service provider 12. The service provider appends this data to a redeemed offer instance record. The offer instance is marked as redeemed. The service provider 12 invoices the advertiser 68 for the offer with redemption information. As a non-limiting example, this redemption information can include but is not limited to at least one of, location, time, amount, offer instance identifier, and the like. The offer instance is marked as invoiced. The advertiser 68 issues payment instruction to the financial institution 74 in response to the invoice step, or the service provider 12 issues payment instruction to the financial institution 74 based on the invoice step. The financial institution 74 pays the service provider 12 for the offer. The service provider 12 issues payment instructions to the financial institution 74 to pay the retailer for the offer. The offer is then marked as paid. In another embodiment, the payment need not be immediate, but can be daily, weekly, monthly and the like.

A report for the retailer is generated, including redemption data for the offer instances redeemed at the retailer, with enough data to identify specific redemption.

In one embodiment, the system 10 enables the retailer to perform financial reconciliation by providing reports that contain transaction identifying information for each offer redeemed at the retailer's checkout system 64. In one embodiment, the reports are made accessible online via one of web site, desktop application, and mobile application. The online report reflects real-time redemption information, without delays from the time of the redemption.

In one embodiment, the system 10 is configured such that an advertiser 68 can perform financial reconciliation by providing reports that contain information necessary for the reconciliation. As a non-limiting example, the information is selected from, redemption time, retailer location, amount and redemption conditions and the like.

In another embodiment, the system 10 allows for auditability by keeping records and providing the advertiser 68, the retailer and any authorized with an audited record.

The retailer then can identify which offer was paid for the relative payment, using the specific redemption information.

Table 1 illustrates one embodiment of information used by the retailer for reconciliation.

In one embodiment of the present invention, the system 10 sorts order of offers, it that it can sort differently for different users 30. In one embodiment, a user profile is stored in the database 16. As a non-limiting example, the user profile can include, statistical information, transaction history, and the like. Advertisers create offers that are stored in database 16, including but not limited to, offer distribution and redemption rules, discount amount, and the like. The server provider 12 specifies a rule, via an algorithm/logic for sorting of offers that assigns an order of presentation of offers based on a combination of one or more of: (i) offer redemption and distribution parameters, as a non-limiting example, dates/times of expiration, product category, discount value and the like; (ii) profitability of the offer publishing/redemption to the service provider (that is service provider 12 can charge advertisers extra for “featured” offers that will appear earlier in the sorting order; (iii) user 30 search parameters; (iv) dates/times and location of originating search request; and (v) a totality of transaction history stored in database 16 up to the point of a search request.

Users 30 use the mobile application 70 of their mobile devices 62 to request a list of the offers, the search request, that match certain criteria. As a non-limiting example, the criteria can include but is not limited to, all offers that are available, specific product categories, expiring times, and the like. The service provider 12 retrieves all the offers that match the user's search criteria for which the user 30 is

TABLE 1
Retailer: Best Stores Inc.

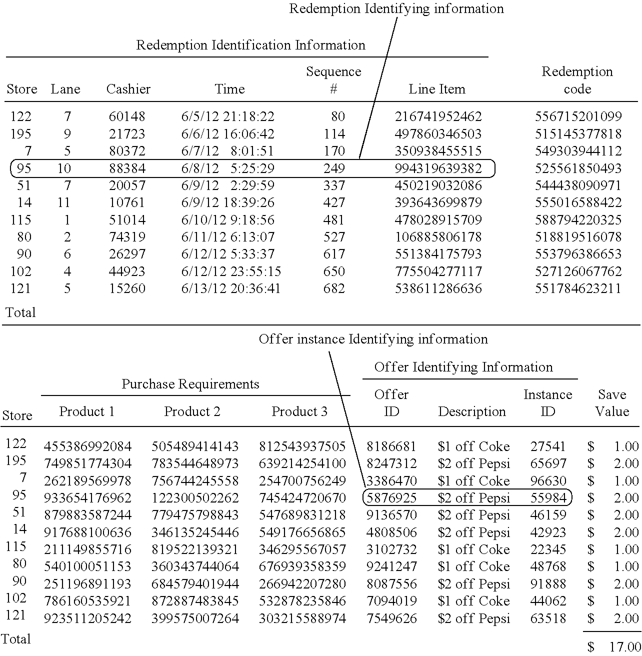

eligible per the offer distribution rules described above. The service provider 12 than applies logic resources to sort the offers to retrieved to be sent back to the user 30. Offers are returned to user's mobile application 70 and are presented to the user 30 in the order determined.

### DETAILED DESCRIPTION

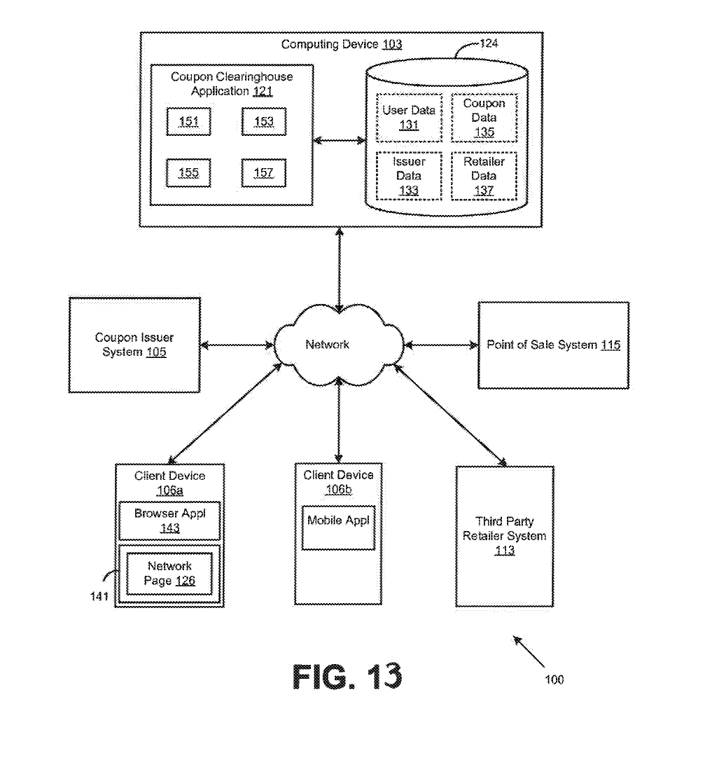

As illustrated in FIG. 13 a networked environment 100 is provided that is another embodiment of network 10. The networked environment 100 includes at least one computing device 103 that is in communication with an offer issuer system 105, at least one user device 106, at least one retailer system 113 and/or at least one retailer checkout system 115. The various components shown in the networked environment 100 of FIG. 13 can be in communication via one or more networks 117, which can include, for example, the Internet, intranets, extranets, wide area networks (WANs), local area networks (LANs), wired networks, wireless networks, or other suitable networks, etc., or any combination of two or more such networks.

The computing device 103 may comprise, for example, a server computer or any other system providing computing capability. Alternatively, a plurality of computing devices 103 may be employed that are arranged, for example, in one or more server banks or computer banks or other arrangements. For example, a plurality of computing devices 103 together may comprise a cloud computing resource, a grid computing resource, and/or any other distributed computing arrangement. Such computing devices 103 may be located in a single installation or may be distributed among many different geographical locations. For purposes of convenience, the computing device 103 is referred to herein in the singular. Even though the computing device is referred to in the singular, it is understood that a plurality of computing devices 103 may be employed in the various arrangements as described above.

The offer issuer system 105 can also represent one or more computing devices with which an advertiser can communicate with the at least one computing device 103. Likewise, the retailer system 113 and/or retailer checkout system 115 can represent one or more computing devices in communication with the at least one computing device 103 implementing the offer functionality described herein. The retailer system 113 can implement a retailer site that implements an electronic commerce system where users can purchase products and/or redeem offers. Similarly, the retailer checkout system 115 can represent one or more point of sale computing devices that are operated by a retailer, where users can purchase products and/or redeem offers.

The computing device 103 is configured to execute various applications such as, for example, an offer application 121 and other applications. The offer application 121 is executed to facilitate distribution and redemption of offers as will be described herein. The offer application 121 can receive an offer specification from an offer issuer system 105 that defines the various properties and/or restrictions associated with an offer funded by the advertiser. In turn, the offer application 121 can make these offers available to users of the offer application 121. Users may “clip” these offers or associate the offers with a user account. Users can then redeem these offers with a retailer system 113, a retailer checkout system 115, and/or other retailer outlets, where the offer application 121 facilitates authentication of the user, validation of the offer, and encumbrance of the offer. In this context, encumbrance of an offer can refer to expiring the offer or decrementing a number of uses available for the offer. The offer application 121 can also receive purchase confirmations and/or settlement requests from retailer systems 113, retailer checkout systems 115, or other retail outlets in connection with purchases made by users for which an offer issued by the offer application 121 to the user were used.

Accordingly, the offer application 121 can issue reimbursements to retailer systems 113, retailer checkout systems 115, or other retail outlets and/or their operators for discounts or other promotions designated by the offer. The offer application 121 can also generate reporting metrics for an advertiser that includes various statistics and information regarding offer redemption, the users that clip offers, user purchasing history, user browsing history, etc. Additionally, the offer application 121 can generate an invoice for an advertiser in connection with reimbursements paid to retailer sites and/or retailer checkout systems. Additional details and variations of the operation of the offer application 121 will be described herein.

The computing device 103 can include at least one data store 124, which can be database 16 that can include data and applications operable to provide access to the data stored therein. It should be appreciated that the data store 124 may or may not reside within a computing device 103, but may be accessible via a network to the computing device 103. The data store 124 may be used to store user data 131 associated with user accounts of users of the offer application 121. User data 131 can include, for example, user profile data, which can include demographic information about a user, shipping addresses, telephone numbers, payment information, e-mail addresses, purchasing history, product browsing history, an offer usage history, an offer clipping history, affinity groups with which the user is affiliated, and other data related to users. The user data 131 can also include data regarding offers the user has clipped and are presently associated with a user account. User data 131 can also include marketing information that is imported into the data store 124 such as from a marketing database. As will be described in further detail herein, the offer application 121 can also generate offer and/or product recommendations by leveraging the data regarding users of the offer application 121. The user data 131 also facilitates targeting of offer campaigns created by an advertiser, as a campaign can be targeted at specific users based upon a purchase history, browse history, demographic information, or other information. Digital offer campaigns can also be targeted towards members of a specific affinity group and/or membership club.

The data store 124 can also include advertiser data 133, which includes data regarding advertisers 105. The advertiser data 133 can include various data regarding an advertiser account accessible to the offer application 121. For example, the advertiser data 133 can include profile data regarding an advertiser, such as, but not limited to, data regarding payments for offer campaigns, products available via an electronic commerce system that are associated with the advertiser, offers issued by and associated with the advertiser, and other data as can be appreciated.

Offer data 135 can include data regarding specific offers that are specified by an advertiser. As noted above, an advertiser can, via an offer issuer system 105, create an offer campaign that is facilitated by the offer application 121 by transmitting an offer specification to the offer application 121. An offer specification can include various information regarding one or more offers, such as a product identifier associated with the offer as well as targeting criteria. Targeting criteria associated with an offer can define requirements for users to which an offer should be made available by the offer application 121. A offer specification can also specify a promotion associated with an offer, which can include a discount amount the advertiser is willing to reimburse to a retailer, a complimentary or discounted product provided is association with a particular product, and other offer promotions as can be appreciated. A discount amount can include a fixed amount and/or a percentage of a selling price. The offer specification can also specify an offer expiration date and/or campaign budget, which describes a maximum amount an advertiser is willing to reimburse retailer sites and/or retailer checkout system operators in connection with an offer campaign.

The offer specification can further include retailer restrictions, which can limit those retailers with which an offer is eligible to be redeemed. In this way, in one embodiment, an advertiser communicating with the offer application 121 via an offer issuer system 105 can limit an offer campaign to authorized dealers of a product sold by the advertiser. In another embodiment, the advertiser can limit an offer campaign to retailers that served a desired demographic. Other variations should be appreciated and will be discussed in more detail herein.

The data store 124 can also include retailer data 137, which includes data regarding retailer systems 113, retailer checkout systems 115, and/or other retail outlets and their operators. Retailer data 137 can include information regarding redemptions of offers issued by the offer application 121 by users with various retailers. The offer application 121 can facilitate redemption of offers with retailers who may operate retailer systems 113, retailer checkout systems 115 or other systems and store data regarding the redemption in retailer data 137. Retailer data 137 can include a volume of redeemed offers, an account balance associated with a retailer, data regarding a fraud history, data regarding products available via a particular retailer, and other data as can be appreciated. Additionally, retailer data 137 can include identifiers that specify an identity of various retailer checkout systems 115 that may be associated with a retailer. As can be appreciated, a retailer may operate numerous retailer checkout systems 115 that can interact with the offer application 121. An identifier can be stored in retailer data 137 in order to identify a retailer associated with a retailer checkout system 115 and record information about offer redemptions at the retailer checkout system 115 as well as enforce offer restrictions.

The data store 124 can also include other data related to users, advertisers, retailers and offers as can be appreciated, but are not necessary to discuss herein for an understanding of the various embodiments of the invention. Additionally, it should be appreciated that the data store 124 can be implemented in a separate computing device that may be located in a separate installation or location. The depicted table structure of the data store 124 is one example of how data can be structured therein according to embodiments of this invention. However, should be appreciated that data can be structured in many different ways across multiple data stores implemented in various computing devices. As one example, data related to users, advertisers, offers, retailers, and other data can be extracted by the offer application 121 by performing queries against data stored in the data store in wholly different table structures. Accordingly, it should be appreciated that the depicted data store 124 and the table structure shown therein is but one example given for ease of depiction and explanation of various embodiments of this invention.

At least one user 106 facilitates communication by a user with the offer application 121 as will be described. The user 106 may comprise various types of computer systems such as, for example, a desktop, laptop, or other computer system with like capability. To this end, the user 106 may also comprise a personal assistant, cell phone, or other portable device with like capability as can be appreciated. The user 106 may interface with the computing device 103 using various applications such as a browser application, dedicated applications, or other applications as can be appreciated. In one embodiment, various user interfaces can be generated on a display device of the user 106 to facilitate interaction with the various systems or components implemented on the computing device 103. In this way, users may interact with the offer application 121 in order to view and/or clip offers available in an offer system implemented by the offer application 121.

As will be described in further detail herein, the offer application 121 can provide one or more offer user interfaces with which a user may interact on a user 106 in order to clip offers rendered in the user interface. The offer application 121 can display offers according to various categories and generate offer recommendations based on a user profile, which can also be displayed in an offer user interface on a user.

In one embodiment, the user 106a can comprise a computing device in communication with a display device 141. The user 106a can display various user interfaces generated by the offer application 121 in connection with implementing an offer system. In one embodiment, the user 106a can execute a browser application 143 configured to render a network page 126 containing an offer user interface. In another embodiment, in the case of a mobile device employed as a user 106b, an offer user interface can be rendered in the user device 106b by a mobile application 145 that is tailored to access and communicate with the offer application 121.

The offer issuer system 105, retailer system 113, and/or the retailer checkout system 115 can also communicate with the offer application 121 via user interfaces rendered in a browser executed in corresponding computing devices. Additionally, they may communicate with the offer application 121 via application programming interfaces (API's) provided by the offer application 121. As one example, the offer application 121 can provide a web service API with which retailer systems 113 and/or retailer checkout systems 115 can communicate in order to facilitate redemption of an offer by a user in association with a purchase of products in a virtual shopping cart and subsequent reimbursement of a promotion provided to the user in connection with the sale.

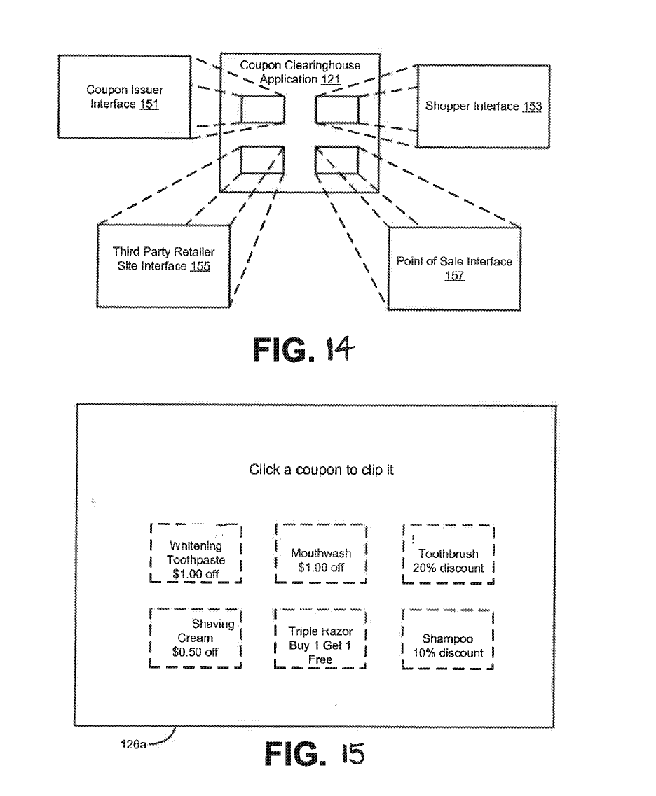

Accordingly, in order to manage the various interactions with the various entities in an offer system, the offer application 121 can provide various interfaces that facilitate communication with offer issuer systems 105, users on a user 106, retailer system 113, and/or retailer checkout systems 115. To this end, the offer application 121 can execute an offer issuer interface 151, a shopper interface 153, a retailer site interface 155, and a point of sale interface 157. The operation of these interfaces is discussed in further detail beginning with the discussion regarding FIG. 14.

Therefore, reference is now made to FIG. 14, which depicts the offer application 121 that can be executed by the computing device 103 shown in the networked environment of FIG. 13. It should be appreciated that the depicted illustration of the offer application 121 and the description of various interfaces is non-limiting, and is presented for ease of describing the various interactions with various entities and/or actors in connection with an offer system implemented by the offer application 121. The offer issuer interface 151 is executed by the offer application 121 to interact with an offer issuer system 105. An offer issuer system 105 can initiate offer campaigns via an offer system implemented by the offer application 121. The offer issuer system 105 can transmit an offer specification that defines at least one offer via a user interface generated by the offer issuer interface 151 and rendered on the offer issuer system 105. Alternatively, the offer issuer system 105 can transmit a data file to the offer issuer interface 151 that contains an offer specification defining at least one offer. The offer issuer interface 151 can parse the data file to determine the parameters of one or more offers defined in the offer specification received from the offer issuer system 105. In another embodiment, the offer issuer interface 151 can provide a network page interface and/or an application programming interface (API) accessible over a network with which an offer issuer can interact in order to define an offer specification.

An offer specification received by the offer issuer interface 151 from an advertiser can define various parameters and/or restrictions regarding one or more offers. An offer specification can define one or more products to which an offer applies. Products can be defined by the offer identifier by identifying one or more product identifiers. A product identifier can include a universal product code, a model number, a serial number, a stock keeping unit, or any other identifier that can uniquely identify a product or a class of products. The offer specification can specify that an offer defined by the offer specification is applicable to a bundle of products by defining multiple products in an offer specification and designating that multiple products identified in the specification are required to be purchased by a user in order for the offer to become applicable. The offer specification can also include an advertiser identifier or tracking number, which can be used by an advertiser to track metrics such as redemption rate, clip rate, and other metrics. To this end, the advertiser interface 151 can provide such an identifier or tracking number in connection with offer metric reports and/or invoices transmitted from the offer application 121 to the offer issuer system 105.

The offer specification received by the offer issuer interface 151 can also define an offer face value or a promotion applicable to one or more products or class of products identified by the offer specification. The promotion can include an amount by which products identified by the one or more product identifiers can be discounted (e.g., a dollar amount, a percentage of a sales price, a percentage of a manufacturer's suggested retail price, etc.). Additionally, the promotion can define one or more complimentary or discounted products that can be provided to a consumer in connection with redemption of an offer. In other words, the promotion can define an amount that the advertiser is willing to reimburse a retailer in connection with redemption of an offer defined by the offer specification. The offer specification can also define an amount which the advertiser is willing compensate an operator of the offer application 121 for each user that views and/or clips an offer.

The offer specification can additionally specify a campaign budget and/or an expiration date associated with one or more offers defined by the offer specification. A campaign budget can specify a total amount the advertiser is willing to reimburse retailers in connection with redemption of an offer. The offer specification can also specify one or more retailers with which the offer can be used. In this way, the advertiser can restrict redemption of an offer to a select number of retailer systems 113, retailer checkout systems 115, or other retail outlets

The offer specification transmitted from an offer issuer system 105 to the offer 121 through the offer issuer interface 151 can also define targeting criteria for the offer. Targeting criteria can specify parameters regarding users of the offer application 121 that are eligible to view and/or clip an offer specified by the offer specification. The targeting criteria, in one example, can specify that a particular offer can only be viewed by a user who has purchased and/or viewed a particular product or class of products. In another example, the targeting criteria can specify that an offer is only available to be clipped by users matching certain demographic information, such as, but not limited to, age, sex, income level, location, etc. In this way, an advertiser associated with an offer can precisely target certain users, as the offer application 121 maintains various information about a user in a user account that can be used to target offers.

The shopper interface 153 that is executed by the offer application 121 can facilitate interactions with a user associated with a user account accessible to the offer application 121. The shopper interface 153 can generate an offer user interface with which a user can view and/or clip offers initiated by offer campaigns from advertisers and that are available via the offer application 121. Alternatively, the shopper interface 153 can transmit data to an application, such as the mobile application 145, that is tailored to allow a user to view and/or clip offers. In some embodiments, a user device 106a/106b may execute user side code to render a user interface based at least upon data regarding offers provided by the shopper interface 153.

Accordingly, shopper interface 153 can authenticate credentials of a user associated with a user account. In some embodiments, the shopper interface 153 can establish a session associated with the user account and the user device 106 on which a user is interacting with the shopper interface 153. The shopper interface 153 can transmit a session identifier, such as a browser cookie, that can be stored in a browser application 143 and/or mobile application 145 that establishes a user identifier associated with the user account. In this way, a user can browse a retailer site 113, which can have access to such a session identifier and/or a user identifier stored therein to establish an identity of the user within an offer system implemented by the offer application 121 and request information from the offer application 121 regarding offers associated with the user. In some embodiments, the shopper interface 153 can also obfuscate and/or encrypt identifying information within such a session identifier to protect the privacy of a user. Interactions regarding authentication of a user identity within an offer system by a retailer system 113 will be described in further detail with reference to the discussion regarding the retailer site interface 155.

The shopper interface 153 can provide offer and/or product recommendations based at least upon user profile data associated with a user account. The offer application 121 can maintain user data 131 that can include offer clipping history data, demographic information, purchase history, and other marketing data regarding a user. Accordingly, the shopper interface 153 can identify products and/or offers to recommend based upon the various profile data accessible to the offer application 121.

The shopper interface 153 can also transmit offers associated with a user account to a mobile device associated with a user. In this way, a user can clip offers available via the offer application 121 and load these offers on a mobile device for redemption with a retailer system 113, a retailer checkout system 115 or other retail outlets. In one embodiment, the shopper interface 153 can transmit a representation of the offer to a mobile application 145 executed on a user device 106b, which can render a bar code on a display device 141 that identifies an offer. A bar code scanner in communication with a retailer checkout system 115 can scan such a bar code for redemption of the offer by the user in connection with a purchase of products identified by an offer specification defining the offer. The retailer checkout system 115 can then communicate with the offer application 121 to validate and subsequently encumber the offer upon redemption. Interactions between a retailer checkout system 115 and the offer application 121 will be discussed in greater detail with reference to the discussion of the point of sale interface 157.

The retailer site interface 155 can be executed to facilitate interactions with a retailer system 113. The retailer site interface 155 can provide an application programming interface (API) or other appropriate interface with which a retailer system 113 can interact to identify users and their associated offers as well as provide data regarding offer redemption and reimbursement requests. In one embodiment, the retailer site interface 155 can provide web service API so that a retailer system 113 can transmit and/or receive text based data or other data regarding the various interactions between the offer system and retailer system 113.

An account accessible to the offer application 121 associated with a retailer system 113 can be authenticated by the retailer site interface 155. In some embodiments, a retailer system 113 can access a session identifier (e.g., a browser cookie) established by the shopper interface 153 when a user authenticates a user account via the shopper interface 153. When a user attempts to purchase one or more products via a virtual shopping cart in the retailer system 113, the retailer system 113 can transmit a user identifier associated with the session identifier to the retailer site interface 155, which can validate the user identity and provide one or more offers associated with the user account to the retailer system 113. Additionally, the retailer system 113 can transmit one or more product identifiers associated with a virtual shopping cart of the user as well as quantities of the products in the cart. Accordingly, the retailer site interface 155 can transmit product identifiers and a promotion associated with the product identifiers so that the retailer system 113 can apply a promotion associated with one or more applicable offers to eligible products associated with a virtual shopping cart of the user.

In some embodiments, the retailer system 113 can encrypt a user identifier and/or session identifier transmitted to the retailer site interface 155, which can decrypt the identifier in order to authenticate a user and provide information regarding offers. In some embodiments, the retailer system 113 can provide additional data regarding a user in addition to the user identifier so that a user identity can be verified. As one example, the retailer system 113 can provide an e-mail address, name, shipping address, phone number, or other identifying data so that if, for example, a browser cookie associated with a session of the user is established on a public computer, offers may not be encumbered by other users. In this scenario, the retailer system 113 can encrypt this additional identifying information, which can be decrypted by the retailer site interface 155.

In another example, the retailer system 113 can hash this additional identifying information and provide a hashed value and/or hash signature to the retailer site interface 155. The retailer site interface 155 can then determine whether the hashed value and/or hash signature corresponding to identifying information of the user matches a hashed value and/or hash signature corresponding to information stored about the user in the data store 124 accessible to the offer application 121.

Upon receiving information regarding applicable offers from the retailer site interface 155, the retailer system 113 can generate a purchase confirmation that can be received by the retailer site interface 155. The purchase confirmation can specify the offers that were applied and/or a promotion provided to the user in connection with the purchase. Upon receiving a purchase confirmation associated with a particular user as well as one or more offers applied to a purchase, the offer application 121 can encumber the offers associated with the account of the user. The purchase confirmation can also provide a shipment confirmation and/or shipment tracking data associated with the purchase, so that the retailer site interface 155 can validate shipment of the products. In one example, reimbursement of a retailer site can be initiated when the retailer site interface 155 receives a purchase confirmation from the retailer system 113. In other embodiments, the retailer system 113 can transmit a settlement request or reimbursement request in connection with a purchase confirmation to the retailer site interface 155, which outlines an amount by which the retailer 113 is to be reimbursed in connection with redemption of an offer by a user. Accordingly, the retailer site interface 155 can initiate electronic payment to a retailer site operating a retailer system 113 and transmit a corresponding electronic confirmation. Purchase confirmations and/or reimbursement requests can be exchanged between a retailer system 113 and the retailer site interface 155 on a purchase by purchase basis or on a batch basis, whereby the retailer system 113 transmits a plurality of confirmations and/or an aggregate reimbursement requests associated with a plurality of purchases where offers were applied.

Additionally, if a transaction that is processed by the offer application 121 is cancelled after it is processed; the offer application 121 can receive an order cancellation notice from a retailer system 113 and/or a retailer checkout system 115. Accordingly, the offer application 121 can unencumber an offer associated with a user so that it may be used again. Additionally, the offer application 121 can facilitate reimbursement from a retailer of an offer amount initially paid to a retailer in connection with the transaction.

The retailer site interface 155 can also enforce minimum advertised pricing rules specified by an advertiser in an offer specification. Accordingly, the retailer site interface 155 can receive an advertised selling price associated with a product in a retailer system 113. If the selling price violates a minimum advertised pricing rule specified by the offer specification associated with an offer, the retailer site interface 155 can transmit a message to the retailer system 113 that denies redemption of the offer.

The retailer site interface 155 can also receive an inventory audit report associated with products for which the retailer system 113 redeemed offers on behalf of users. In this way, the retailer site interface 155 can perform a form of fraud detection. In some embodiments, an inventory audit report can include proof that a retailer site has paid for inventory covering reimbursement requests submitted by one or more retailer systems 113 associated with a retailer site to the retailer site interface 155 over a period of time.

In other embodiments, the retailer site interface 155 can transmit data regarding offers associated with a user account that are in turn associated with products that may not be in a virtual shopping cart on the retailer system 113. In this way, the retailer system 113 can provide additional product recommendations for products available via the retailer system 113 that are relevant to offers associated with a user account, even though these products may not be in a virtual shopping cart of the user. Additionally, the retailer site interface 155 can transmit information regarding offers available via an offer system implemented by the offer application 121 that are not presently associated with a user account, and that correspond to products available via the retailer system 113 so that the retailer system 113 can recommend these products and/or offers.

The retailer checkout system interface 157 can be executed by the offer application 121 to facilitate redemption of offers in a retailer checkout system 115 in communication with an offer system implemented by the offer application 121. As noted above, in one embodiment, offers associated with a user account can be transmitted to a mobile application 145, which can display a bar code or provide another identifier associated with the offer. In some embodiments, a mobile device can wirelessly communicate with the retailer checkout system 115 via a wireless networking protocol and perform a handshake with the retailer checkout system to exchange data. In other embodiments, the retailer checkout system 115 and a mobile device can communicate with a network such as the Internet. A representation of the offer can be generated by the shopper interface 153 such that it uniquely identifies the offer and/or the user account with which the offer is associated. A retailer checkout system 115 can receive a bar code or other identifier associated with the offer and transmit the identifier to the retailer checkout system interface 157 to validate whether the offer should be redeemed or honored by the retailer checkout system.

The point of sale interface 157 can validate the offer presented by a user via a mobile device by receiving an identifier that identifies the offer as well as products associated with a purchase in the retailer checkout system 115. The point of sale interface 157 can then determine whether a promotion associated with the offer should be provided to the user in connection with the purchase by determining whether the products associated with the purchase qualify for the promotion, whether the offer remains valid due to a campaign budget and/or an expiration date specified by an offer specification, and/or whether the offer remains valid due to its being used in excess of a number of uses specified by the offer specification. Upon validating an offer received from the retailer checkout system 115 in this way, the point of sale interface 157 can encumber the offer associated with the user account as described above.

In other embodiments, the retailer checkout system 115 can receive a user identifier associated with a user and transmit the user identifier to the point of sale interface 157, which can transmit one or more offers associated with the user account and/or offers that are applicable to one or more products in connection with a purchase by the user at the retailer checkout system 115. Accordingly, in such a scenario a mobile device or other user 106 associated with a user can perform a handshake to provide a user identifier to the retailer checkout system 115.

The point of sale interface 157, in some embodiments, can also provide a plurality of offers that can be cached in a retailer checkout system 115 and/or on a data store in communication with the retailer checkout system 115 so interactions between the retailer checkout system 115 and/or need not take place in connection with each purchase made at a retailer checkout system 115.

In addition to the above-described interactions between the various interfaces and an offer application 121, the offer application 121 can also syndicate offers from the offer data 135 so that offers can be published on associate sites. Such syndication can increase distribution of offers and encourage clipping and/or redemption of offers. Accordingly, the offer application 121 can generate a publishing feed associated with offers that an associate site can receive and publish. In some embodiments, the publishing feed can take into account relevance to content on an associate site as well as relevance to location based data that can be detected in a user on which a user is viewing an associate site. In this way, by increasing relevance of the offers syndicated by the offer application 121, the offer application 121 can further encourage clipping and/or redemption of the syndicated offers.

Referring next to FIG. 15, shown is a network page 126a that can be generated by the shopper interface 153. The depicted network page 126a includes an offer user interface that is generated by the shopper interface 153 and rendered in a browser application 143 on a user device 106a. It should be appreciated that an offer user interface can also be rendered in a mobile application 145 or any application tailored to access the offer application 121 according to various embodiments of the invention.

The depicted offer user interface illustrates one example of offers that can be displayed to a user for clipping and/or associating with a user account. Additionally, the shopper interface 153 can generate an offer user interface that allows a user to browse and/or clip offers according to a product category. In some embodiments, as in the depicted network page 126a, the shopper interface 153 can display offers associated with a particular advertiser.

Reference is now made to FIG. 16, which depicts an alternative offer user interface. The depicted network page 126b illustrates an offer user interface in which offer recommendations generated by the shopper interface 153 can be displayed. As noted above, the offer recommendations can be based upon a purchase history, offer clipping history, and other data that can be associated with a user account.

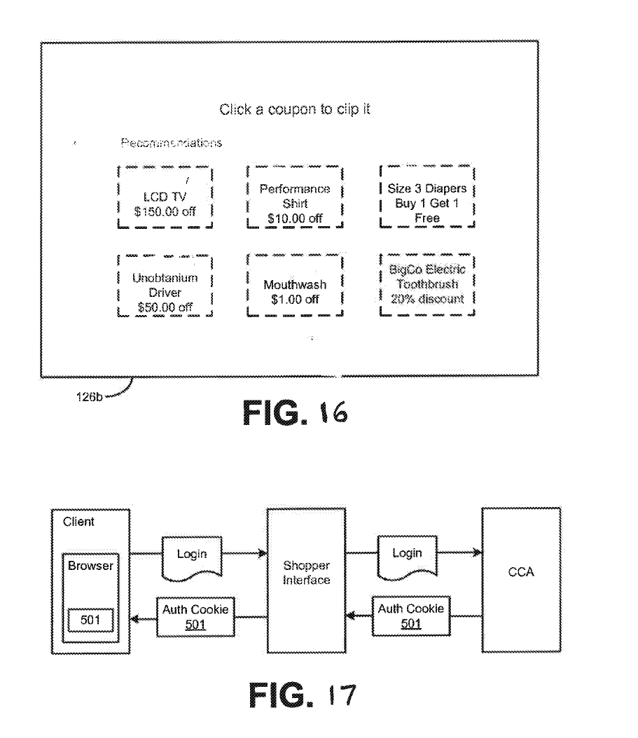

Reference is now made to FIG. 17, which depicts the flow of data between a user device 106a/106b and the shopper interface 153. FIG. 17 depicts one way in which a user can be authenticated, and a session identifier stored in the user device 106a/106b so that retailer sites 113 can access the identifier to retrieve offers associated with a user account. In the depicted figure, a user 106 can submit login credentials to the shopper interface 153, which can verify the login credentials in user data 131 accessible to the offer application 121. Accordingly, a session identifier (e.g., an authorization cookie 501) can be generated that can be stored accessible to a browser application 143 or other application executing on a user.

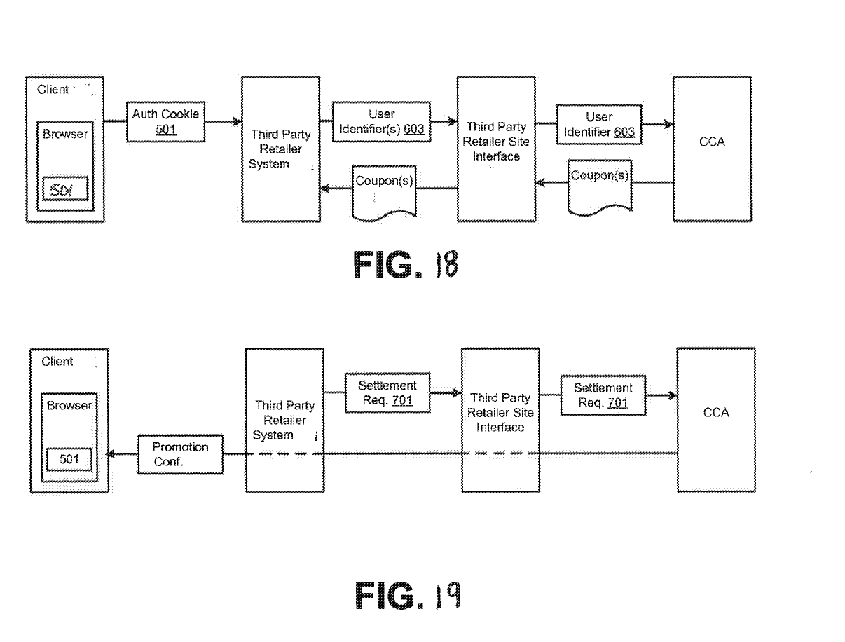

Reference is now made to FIG. 18, which continues the example of FIG. 17 and illustrates a user accessing a retailer system 113 on a user in which an authorization cookie 501 generated by the shopper interface 153 is stored. The browser application 143 executed on a user device 106 can provide the authorization cookie 501 to the retailer site, which can generate a user identifier 603 that can be provided to the retailer site interface 155 for identification of the user. As noted above, the user identifier 603 generated by the retailer system 113 can include data from the authorization cookie 501 and be supplemented with other identifying information associated with a user account and/or a virtual shopping cart in the retailer system 113. The user identifier 603 can also be encrypted or hashed to protect user privacy. The user identifier 603 can also include or be transmitted with product identifiers associated with a virtual shopping cart in the retailer system 113 so that the offer application 121 can identify applicable offers.

Accordingly, the user identifier 603 can be received by the retailer site interface 155, and a user account associated with the identifier identified in the offer application 121. The offer application 121 can, via the retailer site interface 155, transmit at least one offer associated with the user account and/or products in a virtual shopping cart for redemption via the retailer system 113.

Reference is now made to FIG. 19, which continues the example of FIG. 18. Upon completion of a purchase in the retailer system 113, the retailer system 113 can transmit to the retailer site interface 155 a settlement request 701 and/or purchase confirmation as described above. Additionally, in some embodiments, the offer application 121 and/or shopper interface 153 can transmit a promotion confirmation to a user and/or a user 106 associated with the user as a fraud prevention measure as well as a validation measure to ensure the user has received a particular promotion associated with an offer. In this way, a user can verify whether a promotion specified by an offer redeemed by the retailer system 113 is applied to the purchase.

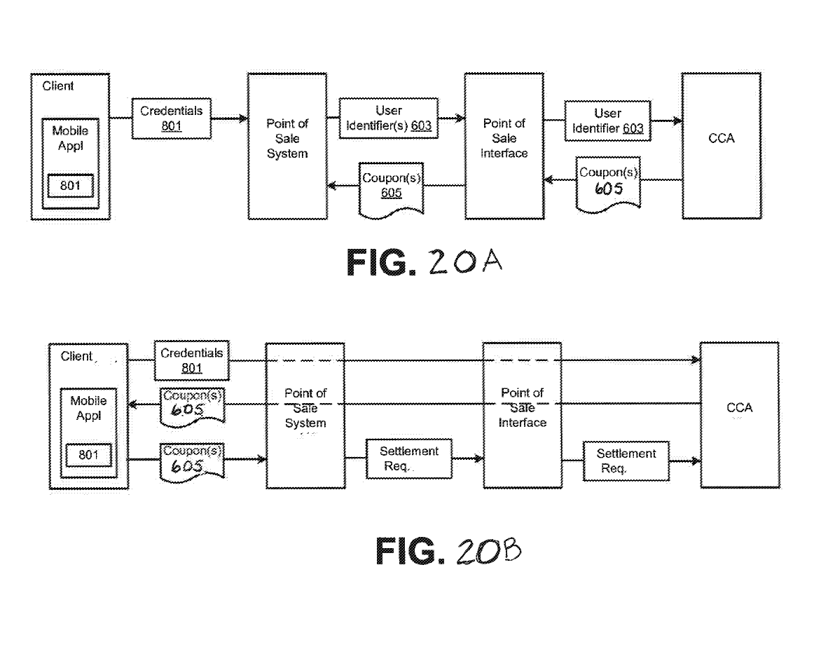

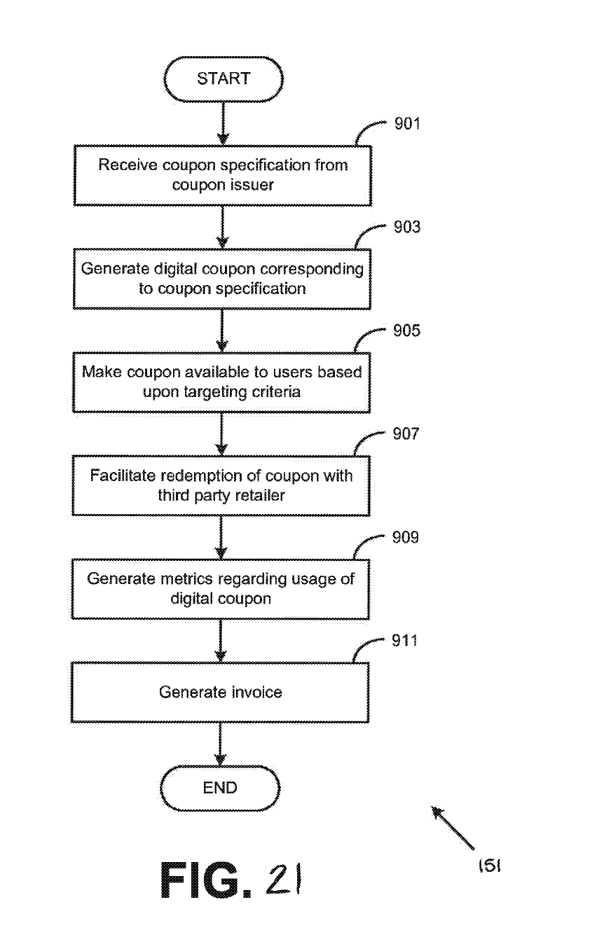

Referring next to FIG. 20A, shown is an alternative example that illustrates the flow of data, in one embodiment between a retailer checkout system 115 and the offer application 121. In the depicted example, a user on a user 106 can use a mobile application 145 to interact with a retailer checkout system. As described above, a mobile application 115 can perform a handshake with a retailer checkout system 115 and provide credentials 801 for authentication with the offer application 121. The retailer checkout system 115 can generate a user identifier 603, which can include the credentials 801 as well as potentially other information that can be used to authenticate the user to the offer application 121, which identify a user account and retrieve offers 605 associated with a user account of the user. The offers 605 associated with the user account and/or the products associated with a purchase in the retailer checkout system 115 can be transmitted to the retailer checkout system 115, which can apply a promotion defined by the offer.

FIG. 20B illustrates an alternative example of interactions with a retailer checkout system 115. In the depicted example, the mobile application 145 can provide credentials 801 directly to the offer application 121 and/or a shopper interface 153. Accordingly, the offer application 121 can transmit offers directly to the mobile application 145. In one embodiment, the mobile application 145 can be configured to capture a UPC, product imagery, or other information about a product and the offer application 121 can identify a product associated therewith, assign the offers to the user account, and transmit any applicable offers 605 to the mobile application 145.

The mobile application 145 can then provide the offers to the retailer checkout system 115, which can apply a promotion specified by the offers and generate a settlement request 807 that can be transmitted to the point of sale interface 157. In some embodiments, the retailer checkout system 115 can transmit a validation request to the point of sale interface 157, which can validate any offers 605 provided by a mobile application 145 to the retailer checkout system 115. Accordingly, the point of sale interface 157 can determine whether offers are valid and issue a validation response to the retailer checkout system 115. If the offers 605 are determined to be valid, then the retailer checkout system 115 can apply a promotion specified by the offers 605 to a purchase at the retailer checkout system 115.

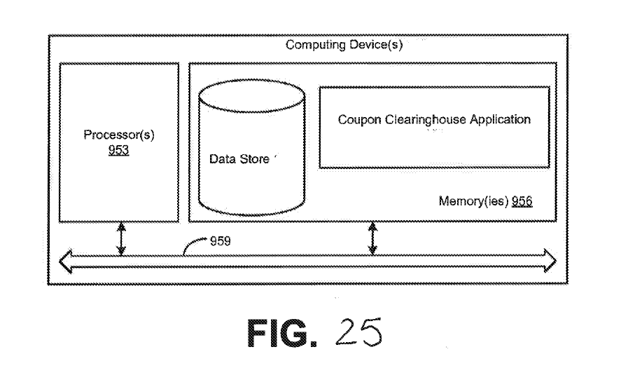

Referring next to FIGS. 21 to 24, shown are various flowcharts that provide examples of the operation of the offer issuer interface 151, the shopper interface 153, and the retailer site interface 155 according to various embodiments. It is understood that the flowcharts of FIGS. 21 to 24 provide merely examples of the many different types of functional arrangements that may be employed to implement the operation of the portion of the offer application 121 as described herein. As an alternative, the flowcharts of FIGS. 21-24 may be viewed as depicting an example of steps of a method implemented in the computing device 103 (FIG. 25) according to one or more embodiments.

With reference to FIG. 21, which illustrates one example of operation of the offer issuer interface 151, beginning with box 901, an offer specification is received from an advertiser, the offer specification defining at least one offer. In box 903, an offer is generated by the offer application 121. In box 905, the offer is made available to users of an offer system implemented by the offer application 121 based upon targeting criteria specified in the offer specification.

In box 907, the offer application 121 can facilitate redemption of the offer with retailer sites, and in boxes 909 and 911, the offer issuer interface 151 can generate metrics regarding distribution, clipping and usage of the offer as well as invoice the advertiser for reimbursements paid by the offer system implemented by the offer application 121 to retailer sites 113 in connection with offer redemptions.

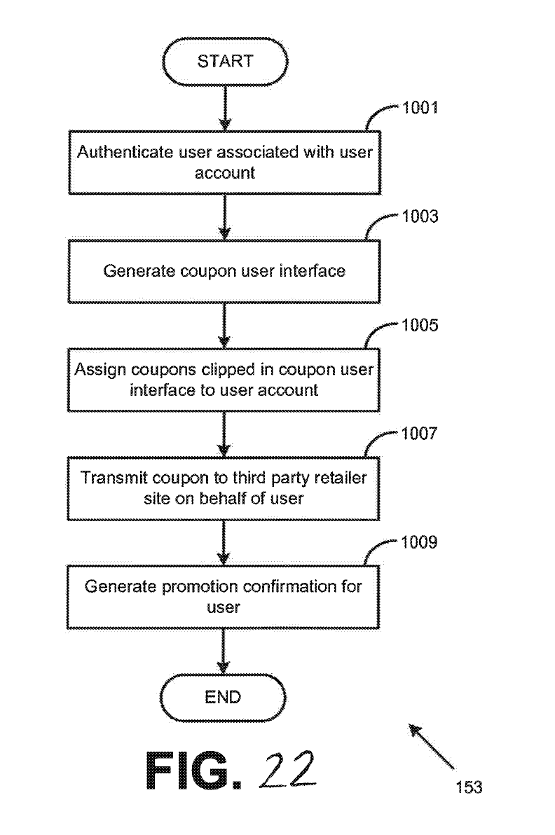

Reference is now made to FIG. 22, which illustrates one example of operation of the shopper interface 153 executed by the offer application 121. Beginning with box 1001, the shopper interface 153 authenticates a user associated with a user account accessible to the shopper interface 153. In box 1003, the shopper interface 153 generates an offer user interface with which a user can view and/or clip offers available via the offer application 121. In box 1005, the shopper interface assigns offers clipped by the user to a user account associated with the user. In box 1007, the shopper interface transmits one or more offers associated with a purchase to a retailer system 113, a retailer checkout system 115, and/or another retail outlet. In box 1009, the shopper interface can generate a promotion confirmation associated with a purchase for a user.

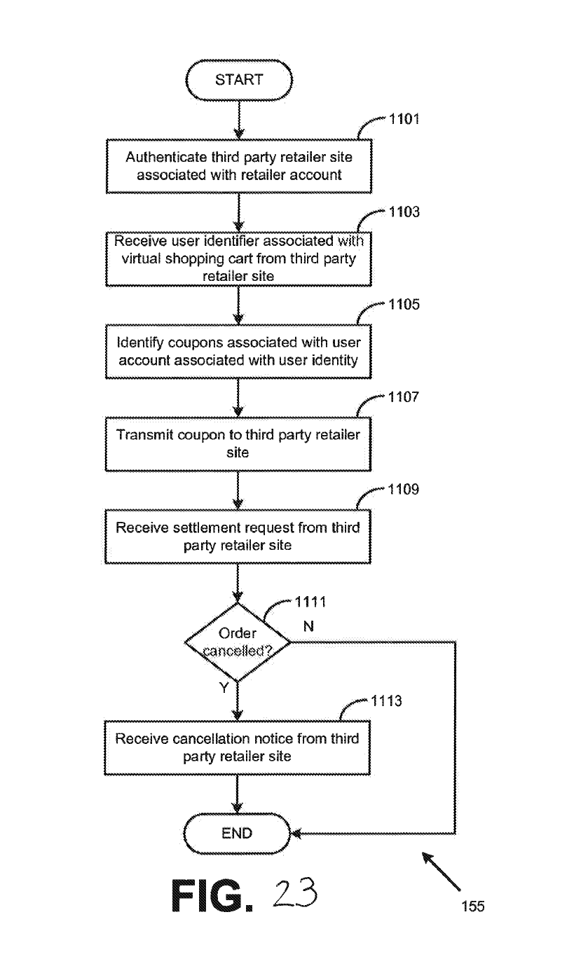

Reference is now made to FIG. 23, which illustrates one example of operation of a retailer site interface 155 executed by the offer application 121. Beginning with box 1101, the retailer site interface 155 authenticates a retailer system 113 associated with a retailer site account in an offer system implemented by the offer application 121. In box 1103, the retailer site interface 155 receives a user identifier from the retailer system 113 that is associated with a virtual shopping cart of a user in the retailer system 113.

In box 1105, the retailer site interface 155 identifies one or more offers associated with the user identity associated with the user identifier and transmits data regarding the offers to the retailer system 113 in box 1107. In box 1109, the retailer site interface 155 can receive a settlement request from the retailer system 113 in connection with a purchase in which offers were redeemed. The settlement request can include information about the amount and quantity of offers redeemed by the user in connection with the purchase. The settlement request can also include a shipment confirmation generated by the retailer site. Accordingly, when the settlement request is received by the retailer site interface 155, the offer application 121 can encumber the offers redeemed in connection with the purchase so that a user may not use the offers more than as specified by a corresponding offer specification. Additionally, if an order placed and/or settled in connection with an offer is cancelled in box 1111, the retailer site interface 155 can receive an order cancellation notice from the retailer site in box 1113. Accordingly, in such a scenario, the retailer site interface 155 can facilitate unencumbering of the offer encumbered in connection with the transaction.

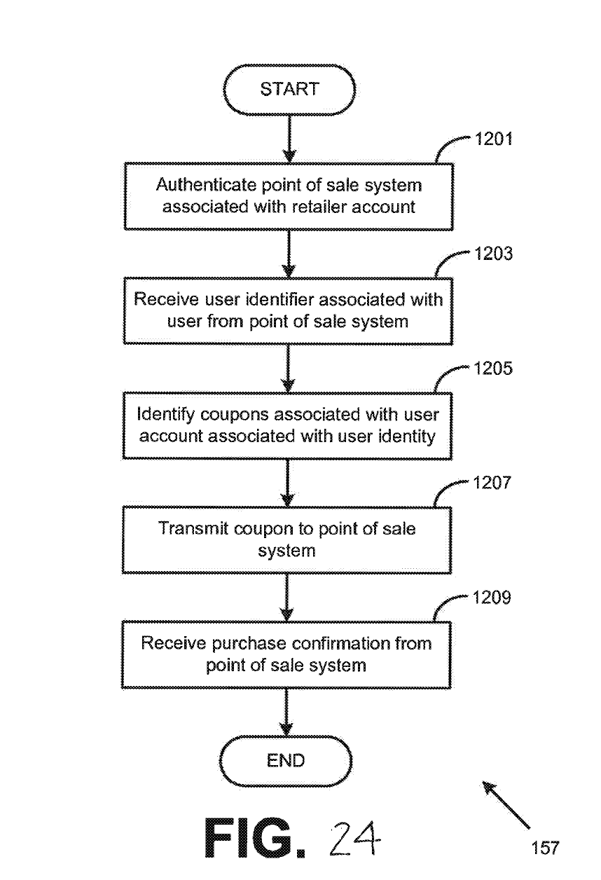

Reference is now made to FIG. 24, which illustrates one example of operation of a point of sale interface 157 executed by the offer application 121. In box 1201, the point of sale interface 157 authenticates a retailer checkout system 115 associated with a retailer account. In box 1203, the point of sale interface 157 receives a user identifier received from the retailer checkout system 115 that corresponds to a user in connection with a purchase via the retailer checkout system 115. The retailer checkout system 115 can also transmit one or more product identifiers associated with products in connection with the purchase. In box 1205, the point of sale interface 157 executed by the offer application 121 can identify offers associated with a user account, and in box 1207, the point of sale interface 157 can transmit identified offers to the retailer checkout system 115. Finally, in box 1209, the retailer checkout system can receive a purchase confirmation from the retailer checkout system in connection with the purchase. The purchase confirmation can also include a shipment confirmation generated by the retailer site. Accordingly, when the purchase confirmation is received by the retailer site interface 155, the offer application 121 can encumber the offers redeemed in connection with the purchase so that a user may not use the offers more than as specified by a corresponding offer specification.

With reference to FIG. 25, shown is a schematic block diagram of the computing device 103 according to an embodiment of the present invention. The computing device 103 includes at least one processor circuit, for example, having a processor 953 and a memory 956, both of which are coupled to a local interface 959. To this end, the computing device 103 may comprise, for example, at least one server computer or like device. The local interface 959 may comprise, for example, a data bus with an accompanying address/control bus or other bus structure as can be appreciated.

Stored in the memory 956 are both data and several components that are executable by the processor 953. In particular, stored in the memory 956 and executable by the processor 953 are the offer application 121 and potentially other applications. Also stored in the memory 956 may be a data store 124 and other data. In addition, an operating system may be stored in the memory 956 and executable by the processor 953.

It is understood that there may be other applications that are stored in the memory 956 and are executable by the processors 953 as can be appreciated. Where any component discussed herein is implemented in the form of software, any one of a number of programming languages may be employed such as, for example, C, C++, C#, Objective C, Java, Javascript, Peri, PHP, Visual Basic, Python, Ruby, Delphi, Flash, or other programming languages.

A number of software components are stored in the memory 956 and are executable by the processor 953. In this respect, the term “executable” means a program file that is in a form that can ultimately be run by the processor 953. Examples of executable programs may be, for example, a compiled program that can be translated into machine code in a format that can be loaded into a random access portion of the memory 956 and run by the processor 953, source code that may be expressed in proper format such as object code that is capable of being loaded into a random access portion of the memory 956 and executed by the processor 953, or source code that may be interpreted by another executable program to generate instructions in a random access portion of the memory 956 to be executed by the processor 953, etc. An executable program may be stored in any portion or component of the memory 956 including, for example, random access memory (RAM), read-only memory (ROM), hard drive, solid-state drive, USB flash drive, memory card, optical disc such as compact disc (CD) or versatile disc (DVD), floppy disk, magnetic tape, or other memory components.

The memory 956 is defined herein as including both volatile and nonvolatile memory and data storage components. Volatile components are those that do not retain data values upon loss of power. Nonvolatile components are those that retain data upon a loss of power. Thus, the memory 956 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 953 may represent multiple processors 953 and the memory 956 may represent multiple memories 956 that operate in parallel processing circuits, respectively. In such a case, the local interface 959 may be an appropriate network that facilitates communication between any two of the multiple processors 953, between any processor 953 and any of the memories 956, or between any two of the memories 956, etc. The local interface 959 may comprise additional systems designed to coordinate this communication, including, for example, performing load balancing. The processor 953 may be of electrical or of some other available construction.

Although the offer application 121 and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowcharts of FIGS. 9-12 show the functionality and operation of an implementation of portions of the offer application 121. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 953 in a computer system or other system. The machine code may be converted from the source code, etc. If embodied in hardware, each block may represent a circuit or a number of interconnected circuits to implement the specified logical function(s).

Although the flowcharts of FIGS. 9-12 show a specific order of execution, it is understood that the order of execution may differ from that which is depicted. For example, the order of execution of two or more blocks may be scrambled relative to the order shown. Also, two or more blocks shown in succession in FIGS. 9-12 may be executed concurrently or with partial concurrence. Further, in some embodiments, one or more of the blocks shown in FIGS. 9-12 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present invention.

Also, any logic or application described herein, including offer application 121, that comprises software or code can be embodied in any non-transitory computer-readable medium for use by or in connection with an instruction execution system such as, for example, a processor 953 in a computer system or other system. In this sense, the logic may comprise, for example, statements including instructions and declarations that can be fetched from the computer-readable medium and executed by the instruction execution system. In the context of the present invention, a “computer-readable medium” can be any medium that can contain, store, or maintain the logic or application described herein for use by or in connection with the instruction execution system. The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art Particularly, while the concept “component” is used in the embodiments of the systems and methods described above, it will be evident that such concept can be interchangeably used with equivalent concepts such as, class, method, type, interface, module, object model, and other suitable concepts. Embodiments were chosen and described in order to best describe the principles of the invention and its practical application, thereby enabling others skilled in the relevant art to understand the claimed subject matter, the various embodiments and with various modifications that are suited to the particular use contemplated.

What is claimed is:

1. A system for offer redemption of an offer by a retailer, comprising:
a service provider that includes one or more servers with engines and attached storage, the service provider is in communication with a mobile application running on a user mobile device of a user, the service provider is in communication with an advertiser and the retailer, the service provider configured to be coupled to one or more processors with logic that enable an advertiser to create an offer campaign with details of the offer campaign stored in the attached storage, the details including at least one of, offer distribution rules and offer redemption rules, the one or more processors reviewing transaction line items of the offer and making a determination to push or not push the offer redemption to a retailer check-out system;
logic that allows a user who has created a request for an offer redemption to be received at the service provider; and
wherein the user communicates information to the service provider that allows the service provider to determine a specific retailer checkout system to receive the offer selected by the user.

2. The system of claim 1, wherein the service provider includes an offer function.

3. The system of claim 1, further comprising:
one or more processors that provides for distribution of the offers to users on behalf of the advertiser.

4. The system of claim 1, further comprising:
one or more processors that provides for redemption of an offer with the retailer on behalf of the advertiser.

5. The system of claim 1, further comprising:
one or more processors that provides for that generates an offer metrics report.

6. The system of claim 5, wherein the offer metrics report includes at least one statistic regarding at least one of distribution and redemption of the offer.

7. The system of claim 1, further comprising:
one or more processors that provides that generates an invoice

8. The system of claim 1, wherein the user communicates directly with the retailer.

9. The system of claim 1, wherein the offer distribution rules and offer redemption rules includes at least one offer restriction of an offer budget, the offer budget specifying at least one of: a maximum total number of redemptions of the offer and a maximum total number of offers that can be redeemed by users.

10. The system of claim 9, wherein the at least one offer restriction includes a retailer restriction, the retailer restriction specifying at least retailer that can redeem the offer on behalf of a user.

11. The system of claim 9, wherein the at least one offer restriction includes an offer targeting criteria.

12. The system of claim 11, wherein the offer targeting criteria includes at least one of: demographic information of users to whom the offer is available, at least one product purchase made by users to whom the offer is available, at least one product viewed by users to whom the offer is available, and a geographic location of users to whom the offer is available.

13. The system of claim 12, wherein the service provider restricts users to whom the offer is available by enforcing the offer targeting criteria.

14. The system of claim 1, wherein the offer restriction further includes a minimum advertised price.

15. The system of claim 1, further comprising:
logic that enforces the offer restriction by identifying a minimum advertised price associated with a product on a retailer site; and
logic that denies redemption of the offer if a minimum advertised price exceeds a price specified by the offer restriction.

16. The system of claim 1, wherein the offer specification includes an amount the advertiser commits to pay in connection with a sale of the at least one product.

17. The system of claim 16, wherein the amount the advertiser commits to pay in connection with the sale of the at least one product further includes: an offer face value and a fee associated with redemption of the offer.
